(19) United States
(12) Patent Application Publication
(10) Pub. No.: US 2026/0134714 A1
(43) Pub. Date: May 14, 2026

(54) User Authentication, Spoofing and Replay Attack Prevention, Liveness Detection, and User-and-Document Verification using a Live Video Stream with Spatial Challenges

(71) Applicant: IRONVEST, INC., New York, NY (US)

(72) Inventors: Avi Turgeman, New York, NY (US); Kfir Yeshayahu, Tzur Yigal (IL); Yonatan Ellman, Givat Zeev (IL)

(21) Appl. No.: 19/383,665

(22) Filed: Nov. 9, 2025

Related U.S. Application Data
(60) Provisional application No. 63/720,195, filed on Nov. 14, 2024.

(51) Int. Cl. G06V 40/40; G06F 21/32; G06V 10/74; G06V 30/41; G06V 40/16; G06V 40/20; G06V 40/60

(52) U.S. Cl. CPC G06V 40/45; G06F 21/32; G06V 10/761; G06V 30/41; G06V 40/172; G06V 40/28; G06V 40/67

(57) ABSTRACT

User authentication, spoofing and replay attack prevention, liveness detection, and user-and-document verification using a live video stream with spatial challenges. A camera of an electronic device captures and transmit a live selfie user-facing video, as part of a user registration process. The user is instructed to spatially move his body or face, such that his face would appear within a first particular on-screen shape; and to also, concurrently or simultaneously, spatially hold in his hand or move a particular an identification document such that it would appear within a second on-screen shape. Optionally, the on-screen shape moves on the screen, and the user is required to spatially move the relevant item to keep it within the boundaries of the moving on-screen shape. The system then analyzes the video via computerized vision, to determine whether the user complied with the spatial manipulation challenges.

### CROSS-REFERENCE TO RELATED APPLICATIONS

This patent application claims priority and benefit from U.S. 63/720,195, filed on Nov. 14, 2024, which is hereby incorporated by reference in its entirety.

### FIELD

The present invention is related to the field of electronic devices and systems.

### BACKGROUND

Millions of people utilize mobile and non-mobile electronic devices, such as smartphones, tablets, laptop computers and desktop computers, in order to perform various activities. Such activities may include, for example, browsing the Internet, sending and receiving electronic mail (email) messages, taking photographs and videos, engaging in a video conference or a chat session, playing games, or the like.

Some online operations may be privileged, or may be available only to registered user or logged-in users. For example, a computerized service may firstly require the user to create an account and to define a password; and may then require the user to log-in in order to access particular functionalities.

### SUMMARY

Some embodiments may include devices, systems, and methods of user authentication, spoofing and replay attack prevention, liveness detection, and user-and-document verification using a live video stream with spatial challenges.

For example, a camera of an electronic device of a user may capture and transmit a live selfie (user-facing) video feed or video stream, as part of a log-in process or a user registration/onboarding/account creation process. The user may be instructed to spatially move his body and/or face, such that his face would appear within a first particular on-screen shape (e.g., elongated oval); and to also, concurrently or simultaneously, spatially hold in his hand and/or move a particular physical token (e.g., an identification document, a driver license, a photo ID card, a passport, a birth certificate) such that the physical token would appear within a second on-screen shape (e.g., a horizontal rectangle). Optionally the on-screen shape may move on the screen, such that the user is required to spatially move the relevant item (his face, or his body, or his physical token, or his identification document) to keep it within the boundaries of the moving on-screen shape. The system may then analyze the real-time video feed or video stream, or a recorded video segment, to perform computerized vision and to determine whether or not the user complied with the spatial manipulation challenge/s that were presented to him, in order to provide or support user authentication, user registration/onboarding, and the creation of a unified video feed or video stream or video segment that fuses together the identification card (or other physical token) and the user's face in a manner that also proves liveness and/or prevents or defeats replay attacks.

Some embodiments may provide other and/or additional benefits and/or advantages.

### BRIEF DESCRIPTION OF THE DRAWINGS

FIGS. 1A to 1M are schematic illustrations of an electronic device showing a real-time live selfie video of an end-user that performs a sign-up/log-in process (or other use authentication/verification process), in accordance with some demonstrative embodiments; demonstrating various types of spatial challenges that the system can select/construct/convey to the user, and that the user should perform correctly as part of the process.

FIG. 2 is a schematic block-diagram illustration of a system, in accordance with some demonstrative embodiments.

### DETAILED DESCRIPTION OF SOME DEMONSTRATIVE EMBODIMENTS

The Applicant has realized that some websites or applications or “apps” may require the user to perform a lengthy and/or complex and/or effort-consuming and/or error-prone and/or time-consuming process for onboarding and/or registration and/or enrollment and/or account creation and/or account log-in or sign-in, or for other purposes of user identification or user authentication.

A conventional process may include an “Identity Verification” (IDV) stage, in which the user may be required to provide a photograph of an identification card (e.g., a driver license, a passport), and optionally also a selfie photograph of the user.

For example, realized the Applicant, a banking website or application, or a brokerage firm or securities trading website or application, or a credit card or mortgage company website or application, may require the user to take several photos with his smartphone and to upload them to the platform; such as, a first photo showing only the user, then a second photo showing the front side of the user's driver license (or government issued ID card, or passport), and then a third photo showing the back side of that document.

The Applicant has realized that this process is cumbersome and takes time and efforts from the user, and is also relatively easy for attackers to bypass these requirements, such that an attacker may pose to be a legitimate user and may create an account and/or perform transactions as if the attacker was that legitimate user.

For example, realized the Applicant, an attacker can often find a photo of the legitimate user on social media such as Facebook or LinkedIn, or on a web-page of the company where the legitimate user works; and such photo can be used the attacker to defeat the registration/log-in requirement to take provide a photo of the legitimate user.

Similarly, realized the Applicant, the attacker can use Photoshop or other photo editing tools to take a valid driver license of a particular country or state (e.g., a Florida driver license), and to digitally edit or change or replace letters/numbers/characters in it, to create a fake image of a drive license.

The Applicant has realized that some systems attempt to mitigate these risks, by asking the user to hold his driver license or photo ID next to his face and to take a combined or unified photo of the user with the identification card. However, realized the Applicant, this requirement can also be defeated by attackers who use more sophisticated tools, such as “deep fake” image generators that can prepare an altered image of the user appearing to be holding an identification card.

Some embodiments of the present invention provide systems and method for improved and enhanced and more secure onboarding of new users into such platforms, and/or for authenticating users or verifying the identity of users. For example, some embodiments may require the end-user to take a real-time live “selfie” video stream of the user, that would capture at the same time, in the same field-of-view of the camera that captures that live video stream, both the face of the user and the identification card that the user is holding near his face.

First of all, realized the Applicant, the innovative requirement to provide to the platform a live real-time video stream that shows both the user and the held identification card, already prevents or stops some attackers from proceeding in their planned attack, particularly a novice attacker or an attacker who is not fully equipped to produce high-quality “deep fake” videos. For example, realized the Applicant, many attackers can use Photoshop to modify a still image, but fewer attackers can utilize the suitable tools for producing a high-quality “deep fake” video of the user holding an identification card near his face and/or partially hiding his face. This innovative challenge, by itself, would stop some of the attackers from proceeding with their planned attacks.

Secondly, some embodiments of the present invention would further display on the screen of the end-user device the live “selfie” video stream that the user is required to capture as part of the registration/log-in process; such that this live video stream is not only transmitted upstream to a remote server, but is also shown immediately and in real time to the end-user himself on his screen. The Applicant has realized that this innovative feature by itself may assist in deterring some attackers, if they see that the live video stream is not just being uploaded to some remote server for future analysis, but is also displayed back to them in real time to remind them actively that they are being video-recorded. This, by itself, may deter or stop some attackers or some attacks.

Thirdly, in accordance with some embodiments of the present invention, the system may require that an identification card (e.g., driver license; state-issued/government-issued identification card; passport) would be held and/or spatially manipulated by the end-user in a certain position or location or at the certain angle or slanting or to show a particular characteristic, that cannot be predicted in advance, and that will dynamically and/or pseudo-randomly and/or deterministically change from user to user and from moment to moment; and such that the real-time selfie video stream would capture that particular position/location/spatial characteristic of the object being held by the end-user.

For example, User Adam may be required by the system to hold his driver license such that it hides exactly his right eye, and does not hide his nose and his lips; whereas, User Bob may be required by the system to hold his passport page open such that it hides exactly his left ear and no other parts of his face or body. The system may select from predefined pool or bank of such requirements or challenges, pseudo-randomly and/or partially based on a deterministic selection process, such that an attacker cannot predict in advance which challenge would be presented to him; and this may prevent the preparation of a “deep fake” video that alleges to show the legitimate user with the identification card.

In another example, the system may show on the screen a live real-time capture of the selfie video stream, and may draw on the screen a rectangle or polygon, or oval or box or other shape or frame, into or onto the depiction of the real-time streaming selfie video, and may require the user (via a voice/audible command, via a textual command displayed on the screen, or the like) to place and/or to move or spatially manipulate the object (e.g., the identification card) in the user's three dimensional space, such that the identification card would be located exactly within the boundaries of that on-screen rectangle or polygon (or other shape) within the real-time live video stream that is being captured by the front-facing camera of the electronic device and that is being displayed in real time on the screen of the end-user device.

The specific shape of that boundary, and/or its on-screen location or absolute location or offset position within the frame or tab or window that shows the live video stream, may be selected randomly or pseudo randomly for each user, and/or may be selected based on a deterministic selection process with selection rules, such that each user is allocated a different requirement or a challenge that cannot be predicted in advance by an attacker.

For example, user Carla is holding her driver license in front of her face in a live selfie video stream that is also shown back to her on the screen of her laptop or smartphone; and the platform draws an on-screen yellow rectangle at the upper left region of that real-time streaming selfie video, and the platform requests user Carla to move her driver license in space with her hand such that the depiction of her driver license will appear exactly within the yellow rectangular boundaries that are shown in hat on-screen streaming video.

In contrast, User David holds his passport page in front of his neck, while capturing a real-time streaming selfie video that is also displayed to him on the screen of his device; and the platform may draw an on-screen red circle inside that on-screen depiction of that real-time streaming selfie video, and may require User David to move his open passport in mid-air such that his own passport photo in his passport would appear exactly within the boundaries of that on-screen boundary red circle within that real-time live video stream.

The requirement or the challenge may be conveyed to each user using a textual message that is displayed to the user on the screen; optionally displayed at a different place every time to different users, and/or optionally displayed on or near the actual face of the user that is shown in the displayed real-time selfie video stream; as this may further reduce the risk of an attack that attempts to automatically analyze the textual content of the screen.

Additionally or alternatively, the requirement or the challenge can also be conveyed to the end-user using an audible/speech based command, such that the platform plays an audio clip that says verbally to the user, “Please move your driver license such that it will hide exactly your lips and out your nose”, or “Please place the first page of your passport exactly within the rectangle that is drawn right now with a red frame on your streaming selfie video window”.

In some embodiments the selection of the challenge can be random or pseudo-random, from a pool or bank of such challenges. In other embodiments, the selection may be semi-random and/or may utilize pre-defined selection rules; for example, rules that take into account the age or the geographic location of the end-user, or other user-specific characteristic and/or device-specific characteristic. For example, an older person (e.g., age over N years) may be required to perform a first type of challenge relative to younger users; or, a user located in certain countries (e.g., Russia or China) may be required to perform other challenges than U.S. based users; or the like.

In further embodiments, the challenge may optionally be dynamically composed using an Artificial Intelligence (AI) unit that uses a Large Multi-Modalities Model (LMM or LMMM), such as Llama or ChatGPT 4o, or by a large Vision and Language Model (VLM) or a large Language and Vision Model (LVM), that can visually analyze and “understand” the content of images or video frames or video segments; and such AI unit can dynamically tailor a particular challenge to each user based on analysis and “understanding” of unique user-specific characteristics that the AI unit detects or recognizes in the live video stream. In a first example, User Janet wears only one earring on her left ear, and wears no earrings on her right ear; the LMMM or VLM can analyze a video-frame from that live-stream selfie video, can detect said characteristics that User Janet has only one earring, and can generate a user-specific or user-tailored challenge that tells User Janet to spatially move her driver license in such that it will cover her single earring (without telling the user which ear has the earing). In a second example, VLM or the LMMM can dynamically determine or recognize that user Andrew has a tattoo or a birthmark on his neck and has no tattoos and no birthmarks on his face; and can dynamically compose a challenge that requires User Andrew to place his driver license such that it would exactly hide his tattoo or birthmark (without telling the user where his tattoo or birthmark exists), thereby providing a user-specific and dynamically-tailored challenge that an attacker would find both surprising and difficult to defeat.

In another example, the challenge may require the end-user to rotate or spin or spatially manipulate or spatially move the identification card (or other object that the user holds or shows) in accordance with a particular instruction or pattern. For example, the platform may instruct User Emma to rotate her driver license in her hand 90 degrees clockwise; whereas the platform may instruct User Frank to rotate his drive license in his hand 180 degrees to make it appear upside down; whereas the platform may instruct User George to move his drive license horizontally all the way to the right side of the video frame and then all the way horizontally to the left side of the video frame; whereas, the platform may instruct User Harry to move his drive license vertically up and down four times; and so forth.

In some embodiments, such captured video stream can then be analyzed on the remote server, using such LMMM or VLM or using other Computerized Vision (CV) mechanisms or Image Recognition algorithms (optionally using Machine Learning/Deep Learning or other AI processes), to check whether the user has complied and correctly performed the three-dimensional manipulations and/or spatial movements that were required from him based on the challenge that was provided to him. In some embodiments, one or more frames from the streaming video can be extracted in order to obtain and analyze the data in the identification document (or other object) that is shown to the camera.

In accordance with some embodiments, the system further performs biometric facial comparison between two or more of the following: (a) the image of the user as it appears on the ID card presented by the user in the live real-time video stream, and/or (b) the image of the user itself as it appears in the live real-time video stream, and/or (c) a previously-uploaded/previously-stored reference image of the user from a previous onboarding/registration process if relevant, and/or (d) other previous facial images of the user from previous log-in sessions or from other transactions or from other sources, (e) the image of the user as it appears in the ID card as shown on the screen of the end-user device that is being recorded, (f) the image of the user as it appears in the main region of the screen of the end-user device that is recorded and that displays back to the user the live selfie video; and a match may be required between two (or more) particular items of this list in order to approve the onboarding/the log-in, optionally with other conditions. In some embodiments, the image-portion of the ID card and/or the image-portion of the user's face, as extracted from the live video stream, are also checked by a Deep Fake detector/analyzer.

Some portions of the discussion above or herein may provide examples of showing a Photo ID for showing a driver license or showing a passport page; however, these are only non-limiting examples, and some systems or platform may provide and use requirements to show or to hold or to spatially move or to turn or rotate or to slant other types of documents or other types of objects in order to prove/verify identity or to authenticate users.

In some embodiments, optionally, the drawn on-screen boundary or frame or rectangle or polygon or oval or other shape, can be dynamically animated or moved (e.g., continuously moving, or moving at particular time-points or time-periods) within the live stream of the displayed selfie video; and the user may be required via a voice command or textual command or other means to move the object or the ID card such that it would be and would remain (e.g., for at least N seconds) within that on-screen boundary as it moves or as it changes it on-screen position or location or offset. In a first example, an on-screen Yellow Rectangle is drawn to continuously move slowly on the screen, within the real-time display of the live selfie video that is being captured; and the user is required to move slowly and gradually her drive license such that it will be for at least two consecutive seconds within that drawn moving on-screen boundary. In a second example, the user is required firstly to place his driver license within a first location of an on-screen boundary (e.g., a red rectangle located at the upper-left corner of the selfie video region), and after three seconds, the drawn boundary moves to another region of the captured real-time video and the user is again required to place his driver license within that new on-screen location of that boundary.

In some embodiments, optionally, the system may show two (or more) boundaries on the selfie video stream, and may convey audible or textual instructions to the user to use only a specific one of those on-screen boundaries; in order to further defeat automated attacks. For example, the system may draw, within the frame of the live real-time selfie video, both: (i) a yellow rectangle at the upper-left region, and (ii) a larger green oval at the lower-right region; and the system may convey to the end-user, via a speech/voice-based audio output, “Please place your identification card within the green shape”, or “Please place your identification card within the oval shape”, or “Please place your identification card within the shape that is larger”; and this may further prevent or defeat attacks.

In some embodiments, the challenge may further require the user to spin or rotate or flip or otherwise spatially manipulate the document or the object in his hand, such as to flip the card from showing the front side of the card to the camera to showing the back side of the card to the camera; and the captured video may analyze also the visual correctness of that flipping movement, to analyze whether it was indeed performed by a live human or is it showing characteristics or visual abnormalities or visual indications of an artificially-made/“deep fake” video.

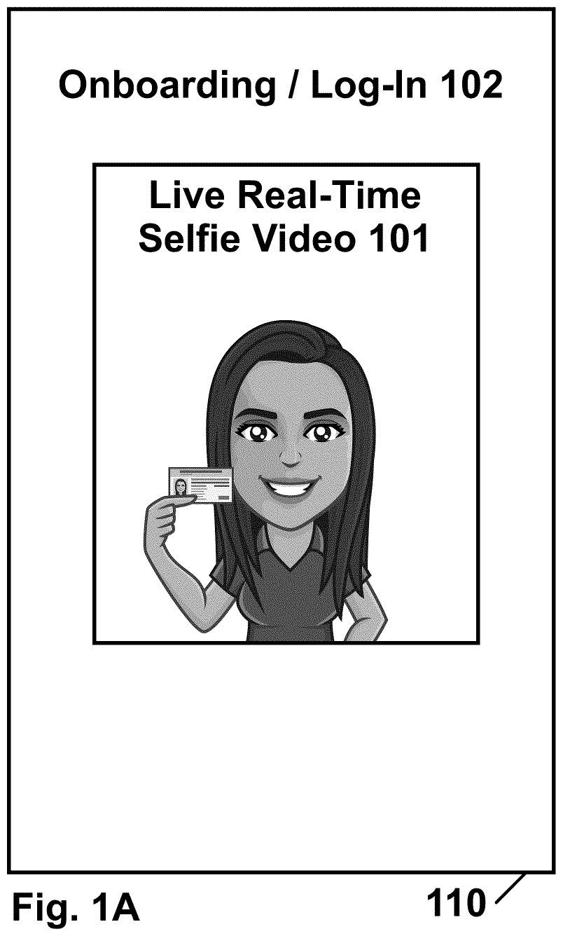

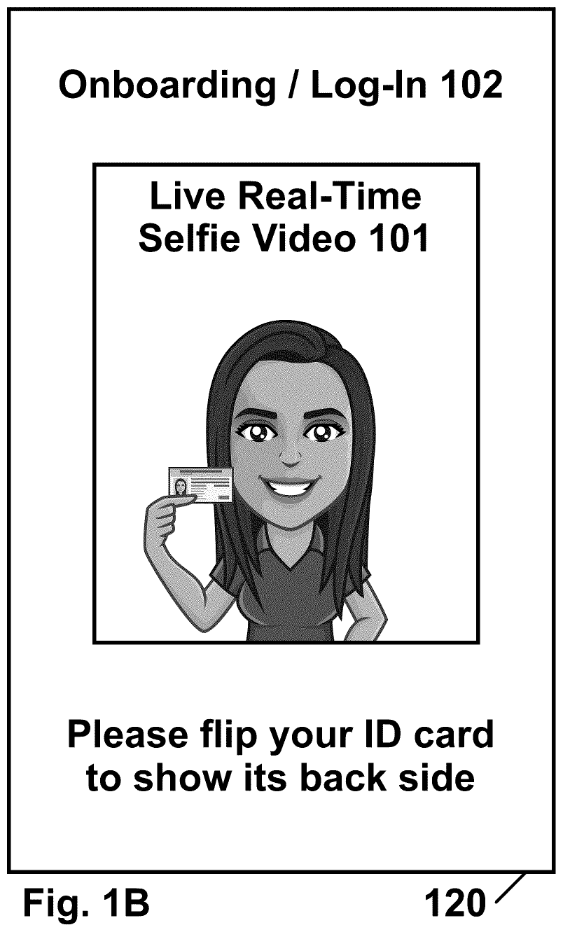

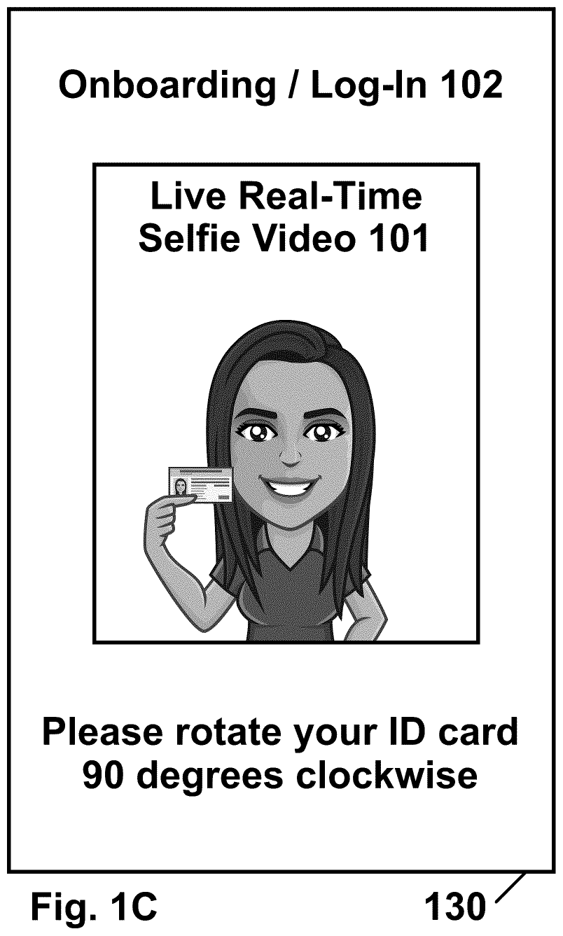

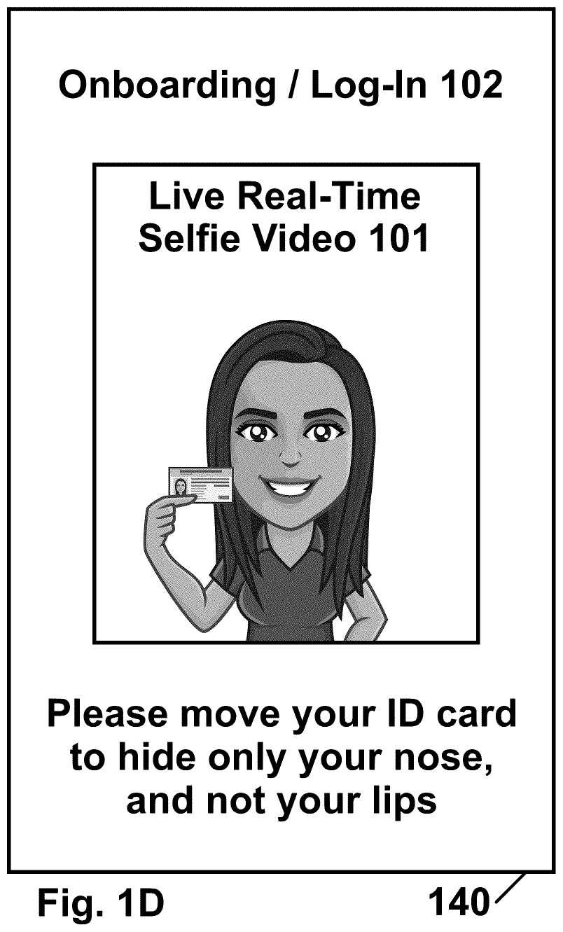

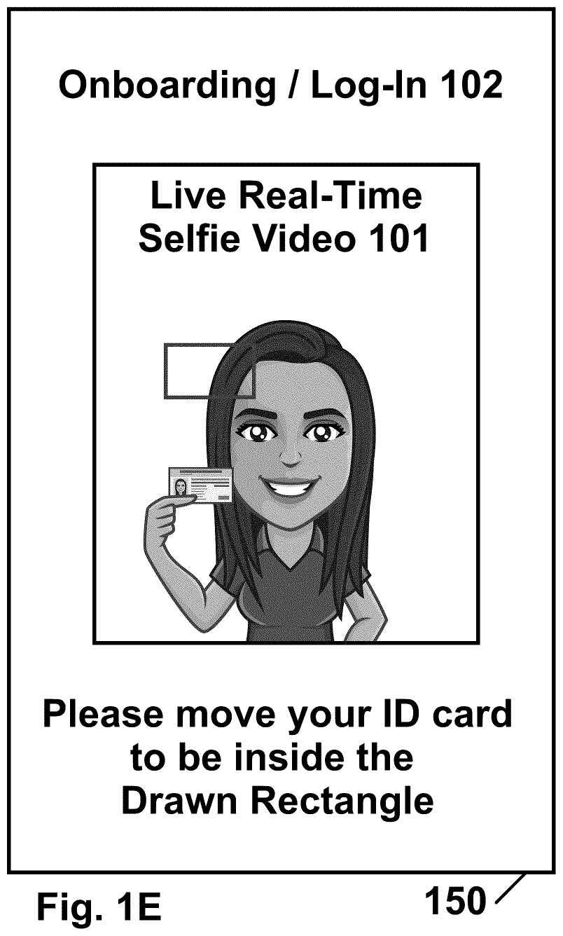

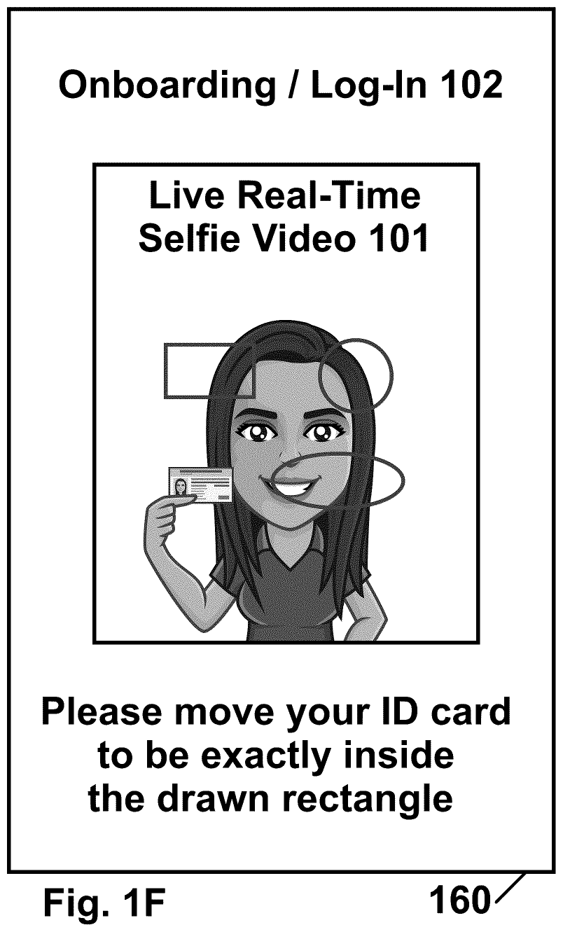

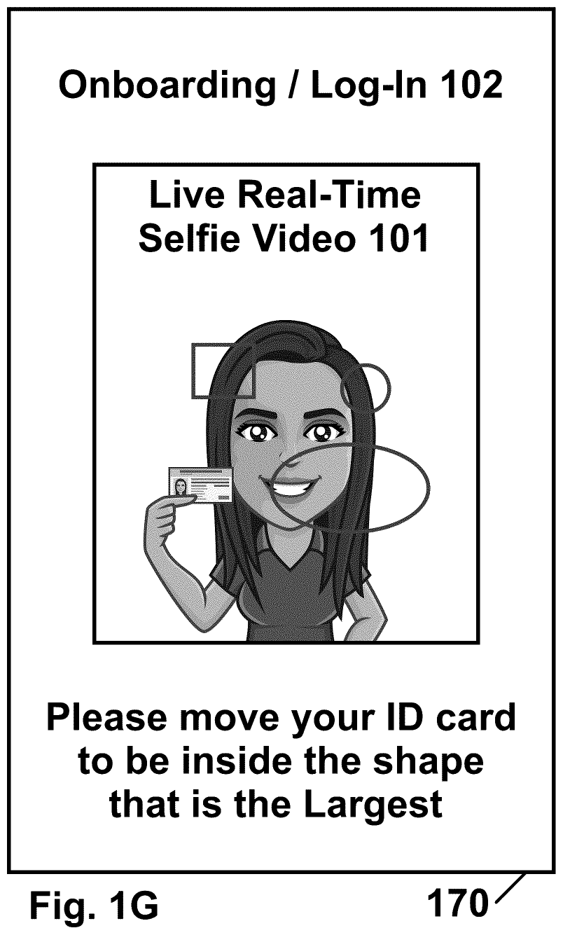

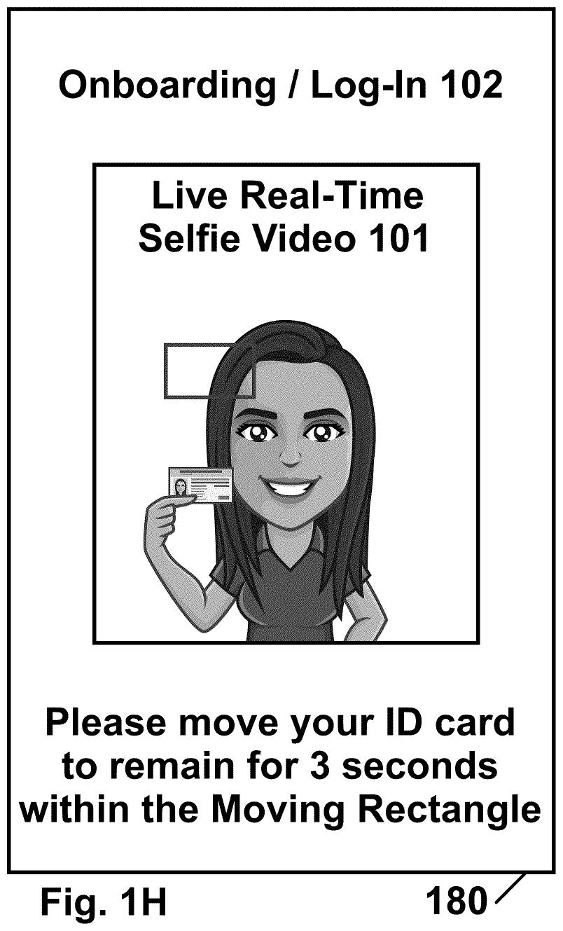

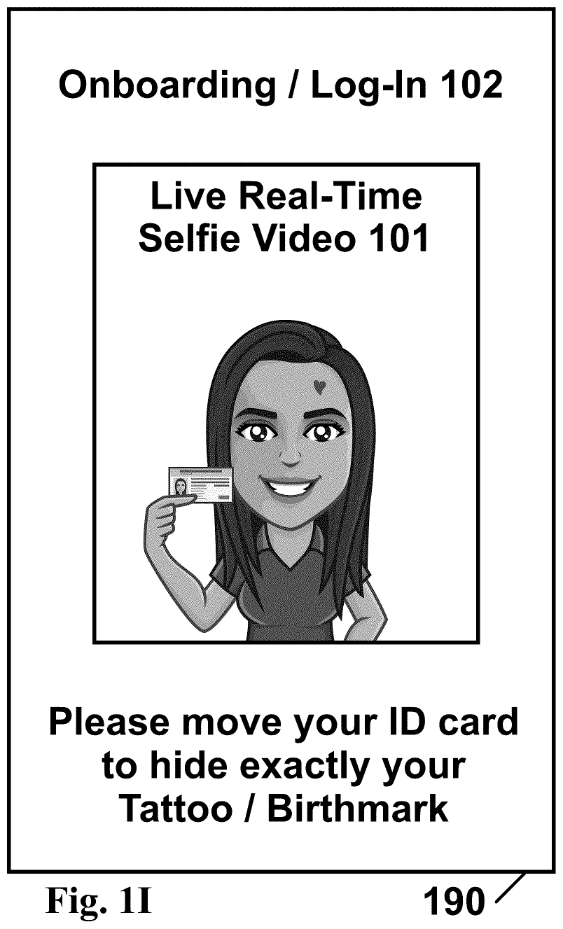

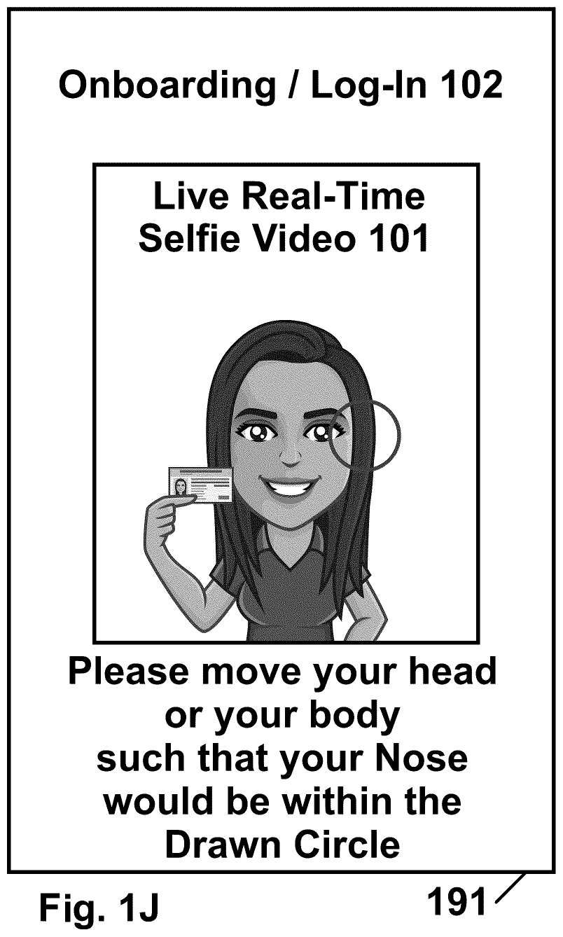

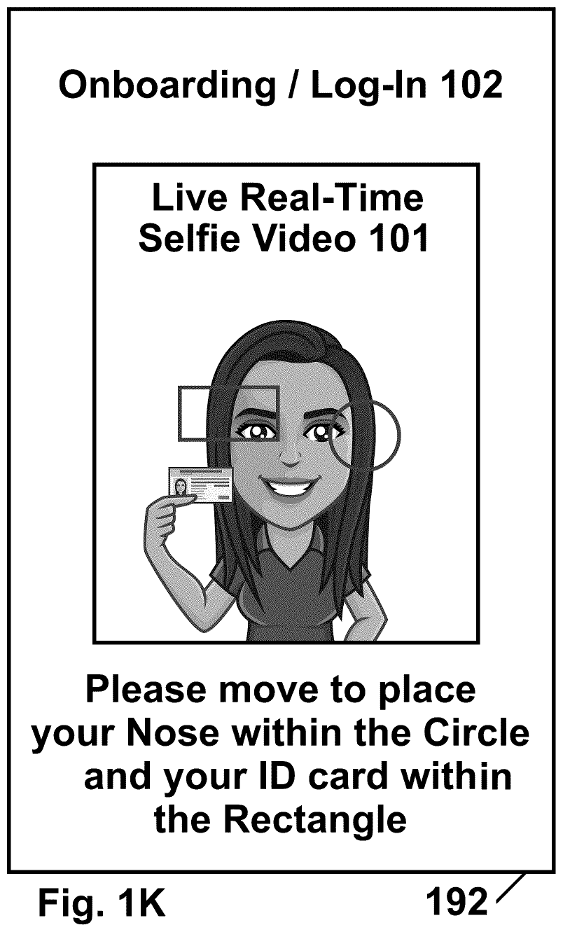

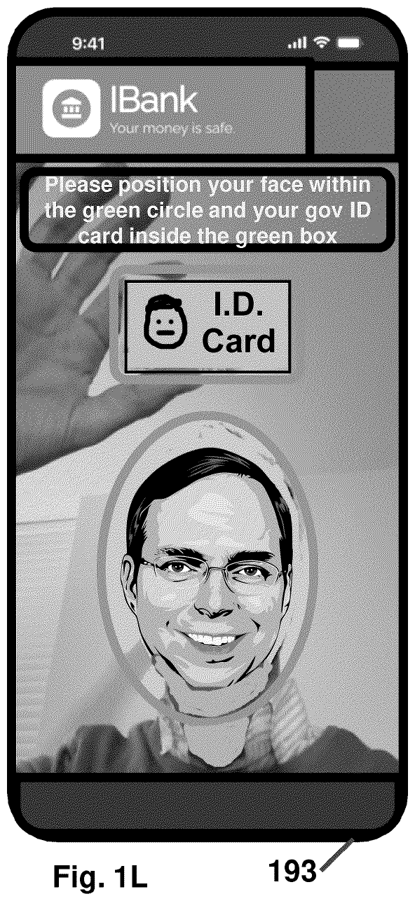

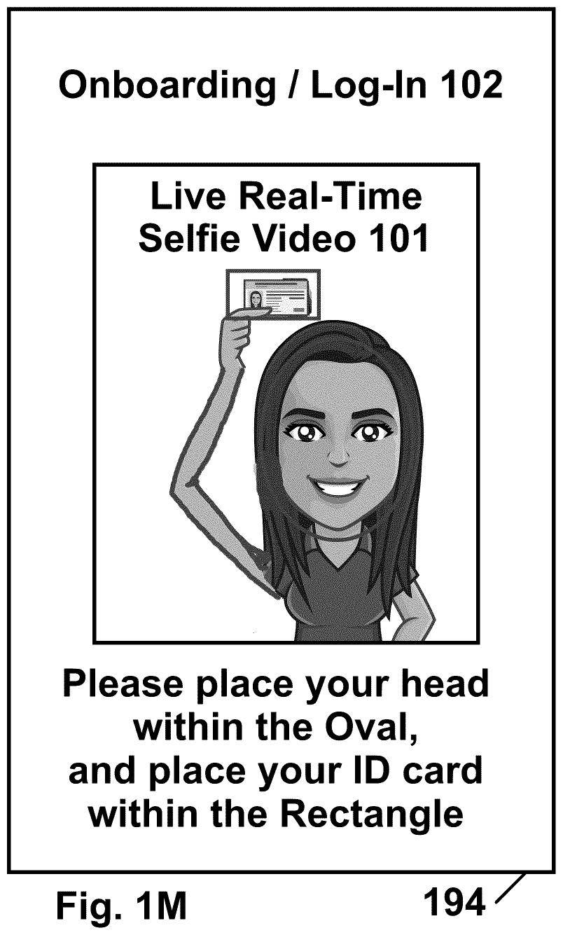

Reference is made to FIGS. 1A through 1M, which are schematic illustrations of an electronic device showing a real-time live selfie video of the end-user that performs a sign-up/log-in process (or other use authentication/verification process), in accordance with some demonstrative embodiments; demonstrating various types of challenges that the system can select/construct/convey to the user, and that the user should perform correctly as part of the process.

Additionally or alternatively, in some embodiments, the challenge may require the user to move/rotate/slant/tilt his face, in order to match particular instruction and/or on-screen drawings or indicators. For example, as demonstrated in some of the drawings, the user may be prompted, “Please move your head or your body such that your Nose will appear exactly within the drawn on-screen circle”; and this may be required instead of, or in addition to, a challenge that requires spatial movement or spatial manipulation of the ID card (or other object/s).

In some embodiments, the system analyzes the real-time video that is streamed from the end-user device to the remote server. In other embodiments, additionally or alternatively, the end-user device performs local video recording of the content of the screen of the end-user device, which depicts therein the ongoing real-time video stream and other information; and that recorded video of the screen is then transferred upstream or is uploaded (in real time, or afterwards) to the remote server for processing. In some embodiments, the processing of the video recording of the screen of the end-user device, which already includes therein a frame or tab or window that shows the real-time selfie video, may provide another obstacle for attackers or against spoofing attacks or other types of attacks. Some embodiments of the present invention may optionally utilize, include, perform and/or provide one or more of the components, units, operations and/or methods that are described in United States patent application publication number US 2023/0230085 A1, titled “User Authentication and Transaction Verification via a Shared Video Stream”, which is hereby incorporated by reference in its entirety; and a copy of that publication is included as Appendix “A” which is an integral part of the specification of this provisional patent application.

Reference is made to FIG. 1A, which is a schematic illustration of a screen 110 of an electronic device, demonstrating an onboarding/log-in interface 102 or content, and embedding therein a real-time live selfie (user-facing) video stream of the end-user, in accordance with some demonstrative embodiments. The end-user is holding an object, such as an identification card, in her hand and shows it to the device's front-facing camera.

Reference is made to FIG. 1B, which is a schematic illustration of a screen 120 of an electronic device, demonstrating a challenge requesting the user to flip her ID card to show its back side to the camera, in accordance with some demonstrative embodiments.

Reference is made to FIG. 1C, which is a schematic illustration of a screen 130 of an electronic device, demonstrating a challenge requesting the user to rotate her ID card by 90 degrees, in accordance with some demonstrative embodiments.

Reference is made to FIG. 1D, which is a schematic illustration of a screen 140 of an electronic device, demonstrating a challenge requesting the user to move her ID card and to position it in a location such that the ID card would hide her nose and would not hide her lips.

Reference is made to FIG. 1E, which is a schematic illustration of a screen 150 of an electronic device, demonstrating a challenge requesting the user to spatially move her ID card such that it would appear inside the rectangle that is drawn within the depiction of her live real-time selfie video stream, in accordance with some demonstrative embodiments. Only one rectangle is drawn, in this example.

Reference is made to FIG. 1F, which is a schematic illustration of a screen 160 of an electronic device, demonstrating a challenge requesting the user to spatially move her ID card such that it would appear inside the rectangle that is drawn within the depiction of her live real-time selfie video stream, in accordance with some demonstrative embodiments. In this example, there are drawn one rectangle, one oval, and one circle; from which the user would also need to identify which is the rectangle to which the challenge refers.

Reference is made to FIG. 1G, which is a schematic illustration of a screen 170 of an electronic device, demonstrating a challenge requesting the user to spatially move her ID card such that it would appear inside the largest shape of several shapes that are drawn within the depiction of her live real-time selfie video stream, in accordance with some demonstrative embodiments. In this example, there are drawn one small square, one small circle, and one significantly larger oval; from which the user would also need to identify that the oval is the largest shape.

Reference is made to FIG. 1H, which is a schematic illustration of a screen 180 of an electronic device, demonstrating a challenge requesting the user to spatially move her ID card such that it would appear and would remain (e.g., for N seconds) inside the rectangle that is drawn and that is slowly moving within the depiction of her live real-time selfie video stream, in accordance with some demonstrative embodiments.

Reference is made to FIG. 1I, which is a schematic illustration of a screen 190 of an electronic device, demonstrating a challenge requesting the user to spatially move her ID card such that it would hide exactly an AI-detected/Computerized Vision recognized tattoo or birthmark or other user-specific feature, in accordance with some demonstrative embodiments.

Reference is made to FIG. 1J, which is a schematic illustration of a screen 191 of an electronic device, demonstrating a challenge requesting the user to spatially move her head or body such that her nose would appear exactly inside the circle that is drawn within the depiction of her live real-time selfie video stream, in accordance with some demonstrative embodiments.

Reference is made to FIG. 1K, which is a schematic illustration of a screen 192 of an electronic device, demonstrating a challenge requesting the user to spatially move her head or body such that: (i) her nose would appear exactly inside the circle that is drawn within the depiction of her live real-time selfie video stream, and also, (ii) her ID card would appear exactly inside the rectangle that is drawn within the depiction of her live real-time selfie video stream, in accordance with some demonstrative embodiments.

Reference is made to FIG. 1L, which is a schematic illustration of a screen 193 of an electronic device, demonstrating an and-user responding correctly to the above-mentioned challenge that required him: (i) to spatially move his head or body such that his face would appear exactly inside the oval or circle that is drawn within the depiction of his live real-time selfie video stream, and also, (ii) to spatially move his ID card such that the ID card would appear exactly inside the rectangle that is drawn within the depiction of his live real-time selfie video stream, in accordance with some demonstrative embodiments. It is note that in such embodiments, a first randomization may be performed with regard to the on-screen/spatial location of the Face of the user that would be required in the challenge, and/or a second randomization may be performed with regard to the on-screen/spatial location of the ID Card (or other document or object) that the user would be required to spatially position in the challenge For example, User Adam may be required to place his face into a left-side oval and to place his ID card into a top-region rectangle; whereas, User Bob may be required to place his face into a right-side oval and to place his ID card into a lower-region rectangle.

Reference is made to FIG. 1M, which is a schematic illustration of a screen 194 of an electronic device, demonstrating an and-user responding correctly to the above-mentioned challenge that required him: (i) to spatially move her head or body such that her face would appear exactly inside the oval or circle that is drawn within the depiction of her live real-time selfie video stream, and also, (ii) to spatially move her ID card such that the ID card would appear exactly inside the rectangle that is drawn within the depiction of her live real-time selfie video stream, in accordance with some demonstrative embodiments.

Some embodiments thus utilize a continuous real-time live selfie (user-facing) video stream and video capture, with visual instructions that provide a spatial user-side challenge that instructs the user where/how to position/move/locate/re-locate/tilt/slant/rotate/otherwise modify the position of the user's face and/or the user's ID card (or other document or object). The challenge is different and/or randomly selected each time, to the same use and/or across different users, to defeat attempts of “replay attack”, and to prevent prediction of which challenge would be presented to which user and what time. The end-user device plays the live video stream, and the screen of the end-user device is recorded and the recording is analyzed in real time and/or subsequently to further authenticate and verify the shown details, and to deduce or determine the exact location of the user's face and the identifying document (or object).

Some embodiments thus provide: (a) an improved User Interface and User Experience, with an all-in-one user experience that includes the selfie and the document verification in a single natural video shot; (b) Boolean detection of spoofing, liveness, virtual camera, video injection, deep fake videos, and other attacks; (c) optionally, some embodiments may further utilize palm biometric and/or fingerprint biometric enrollment/authentication.

Some embodiments may provide multiple solutions to the problems of “deep fake” photos and “deep fake” videos, in which an old/existing photo or an old/existing video of the user are obtained (or, are entirely made in an artificial or synthetic way) and are modified in order to show or to add into them and identification card or other required document or object.

Some embodiment may solve liveliness detection or liveness detection problems, ensuring that the real-time selfie video is fresh, and preventing a “replay attack” of older or previously-captured/previously-fabricated videos.

Some embodiments may also provide security and enhance user experience by providing a single unified process, in which the live video is streamed continuously and the user performs the required actions or challenge(s) in front of the camera and sees the results on the screen, instead of requiring the user to take three different photos and to upload them one by one to the remote server.

Some embodiments may therefore provide solutions to liveliness and liveness detection problems, to replay attacks, to attacks that use “deep fake” photos and “deep fake” videos, and to other attacks in which an artificial photo or video stream are composed or are synthesized by a human attacker or by an automated/AI-based attack unit in an attempt to pose as the legitimate user.

Some embodiments may provide an IDV process (that includes document verification and biometric verification) with Boolean liveness and spoofing detection. The end-user device has a camera that can be used for the purpose of validating the identity of an user. The user is required to perform the following steps, or some of them. (1) Turn on the camera in a video mode, to continuously record a real-time selfie video of the user. (2) A continuous screen capture of the device screen will also be taken, showing the selfie video on the screen. (3) During the selfie video recording, the user is asked to show to the camera one or more objects (e.g., drive license) while their faces are being kept in the frame or the live video; such objects can be different types of ID cards or documents, driver license, passport, government issued ID card, or other documents that include the user's name/picture/signature/other data. (4) The user is asked by one or more means (e.g., on-screen text, audible speech message, visual indicators or marks) to move and place their face and/or the objects in front of the camera in pseudo-random locations within the video frame. Meaning, for each different onboarding process, the location within the frame in which the user is required to position their face and/or the object they hold will be different. (5) In the server side, the coordinates of the face and the object presented in the video will be calculated relative to each other and relative to the screen of the device (through the screen capturing). (6) If the object is positioned in the right location within the selfie video frame, then, a snapshot of both the selfie and the object is be extracted from the video, and is transferred to further analysis to determine whether the selfie is a match to the ID picture and whether the ID was spoofed or not.

Some embodiments may provide a system that includes an end-user device, such as a smartphone or tablet or laptop computer or desktop computer, equipped with a front-side/front-facing camera that can capture a “selfie” video of the user; and also equipped with a screen or touch-screen that can show that live-captured video stream in real time. In some embodiments, the analysis of the video stream can be performed locally within the end-user device, such that the video stream is not transmitted and not uploaded to any remote server; or, the analysis of the video stream can be performed on a remote server or in a cloud-computing system that receives the uploaded video or the up-streamed video and analyzes it in real-time and/or after the full video was uploaded and received; or by using a combination of local analysis with remote analysis of the streamed/captured video.

Some embodiments may provide a system for secure user onboarding and authentication, that enhances protection against impersonation, “deep fake” attacks, replay attacks, and other fraudulent practices; through innovative use of live selfie video streams that incorporate an integral challenge. Recognizing the limitations of traditional photo-based identity verification, which attackers can easily bypass by manipulating static images, some embodiments of the invention require users to engage in a dynamic, interactive process that verifies their identity through a real-time video feed. Unlike traditional methods that only require still photos of identification documents, the system uses a live, real-time “selfie” video stream where both the user's face and identification card are visible in the same frame, preventing attackers from using easily manipulated images. The process includes further layers of security by introducing dynamic, unpredictable challenges tailored to each user. For example, users may be instructed to position their identification card to obscure a specific part of their face, such as an eye or ear, or to move the identification card into a certain shape or frame that is drawn or displayed on-screen (and that can be static or moving). These challenges are randomized or based on user-specific characteristics, making it difficult for attackers to anticipate and reproduce the required actions. Advanced embodiments may further utilize AI models, such as Large Multi-Modalities Models (LMMs) or Vision and Language Models (VLMs), to create individualized challenges based on unique user traits, such as detecting an earring, a tattoo, a birthmark, a necklace, a hair clip, an accessory, or other item that can be referred to within a challenge. In some embodiments, in real-time, the user must align their identification card with dynamically moving on-screen boundaries, and/or may be required to perform spatial movements as directed, adding another layer of security to the verification process. By requiring specific movements, such as rotating the card or positioning it within shifting or moving shapes on the screen, the system ensures that only a live user can meet these demands, preventing replay attacks and artificial “deep fake” videos. Furthermore, the real-time display of the selfie video on the user's device acts as a deterrent, reminding the user that they are being monitored live. The video stream can be analyzed on the user's device, enhancing privacy; or transmitted to a remote server for processing.

Some embodiments provide a method for secure user authentication, comprising: (a) initiating a live selfie video stream of a user on an end-user device; (b) capturing the user's face and an identification document within the same video frame; (c) displaying real-time video feedback on the user's screen; (d) requiring the user to manipulate the document spatially, based on a randomly generated or randomly selected positional challenge; and (e) transmitting the video data to a server for analysis, or performing the video analysis locally, to verify compliance with the challenge.

Some embodiments provide a method for preventing identity fraud during user onboarding or log-in, comprising: (a) starting a live video stream to capture the user's face and a government-issued identification card; (b) presenting the user with an on-screen visual indicator specifying a specific area where the document must be positioned; (c) directing the user to maintain this position for a predetermined duration; (d) applying computer vision techniques to confirm the identification document aligns with the specified area; and (e) signaling successful authentication upon verifying the document's correct position in real time.

Some embodiments provide a method for liveness detection in user authentication, comprising: (a) prompting the user to start a live selfie video on a mobile device having a front-facing camera; (b) instructing the user to hold an identification card next to a specific facial feature; (c) requiring the user to dynamically alter the required position or angle or slanting or position or other characteristic of the identification card in real-time; (d) using artificial intelligence or computerized vision algorithms to assess compliance by analyzing the video feed or video frames; and (e) granting access only upon successful confirmation of a live user completing the spatial requirements.

Some embodiments provide a method for interactive user verification, comprising: (a) initiating a real-time video feed that displays the user's face and an identification document; (b) displaying a pseudo-randomly generated on-screen shape where the user must position the document; (c) requiring the user to move the document within the boundaries of the shape as it shifts or moves across the screen; (d) monitoring the document's movement through video analysis to detect compliance or anomalies; and (e) confirming identity if the user's actions as shown in the selfie video align with the dynamic instructions provided.

Some embodiments provide a method for reducing or preventing replay attacks in digital authentication, comprising: (a) activating a live selfie video that captures both the user's face and identification document; (b) issuing a randomized instruction for the user to move the document to a specific location relative to their face; (c) adjusting the on-screen challenge periodically during the video stream; (d) processing the video in real-time to validate the user's adherence to the spatial requirements; and (e) authenticating the user upon completing the specified task correctly.

Some embodiments provide a method for verifying user identity using dynamic challenges, comprising: (a) capturing a real-time video stream that includes the user's face and identification card; (b) directing the user to position the identification card to partially obscure a specified facial feature; (c) applying artificial intelligence to analyze the video frames and verify the feature is obscured as instructed; (d) updating the instructions based on user performance if required; and (e) confirming authentication once the verification criteria are satisfied.

Some embodiments provide a method for enhanced security in user log-in, comprising:
(a) initiating a live video capture of the user's face and identification document; (b) drawing a specified shape in a designated area on the user's display; (c) instructing the user to spatially align the identification document within the drawn shape; (d) using computer vision algorithms to track the document's position within the shape; and (e) authenticating the user if the document is positioned accurately for a defined duration.

Some embodiments provide a method for secure identity verification with spatial challenges, comprising: (a) activating a live video feed that captures both the user's face and identification document; (b) requiring the user to hold the document at a specific position or location or angle or slanting or offset relative to their face or body; (c) displaying a target area on-screen where the document must remain visible; (d) applying image recognition or computerized vision analysis to ensure the document's proper alignment; and (e) confirming the user's identity upon verification of the document's positioning.

Some embodiments provide a method for detecting fraudulent login attempts, comprising: (a) capturing a live selfie video stream of a user holding an identification card; (b) instructing the user to rotate or flip the document in view of the camera; (c) analyzing the video feed in real-time to assess whether the movement is performed by a live user; (d) detecting any inconsistencies or abnormalities or visual inaccuracies or visual mistakes that indicate a fabricated video; and (e) authenticating the user only if the movement matches expected natural behavior a human.

Some embodiments provide a method for real-time authentication through adaptive user prompts, comprising: (a) starting a live video stream of the user with an identification document visible; (b) dynamically generating and drawing an on-screen shape where the document must be spatially positioned; (c) providing the user with audible instructions to adjust the document's spatial placement; (d) using computerized vision or video/image recognition modules or using a VLM/LMMM to verify the accuracy of the user's positioning of the identification card (or other object); and (e) authenticating the user upon satisfying the live positional requirements that were presented to this user in the challenge.

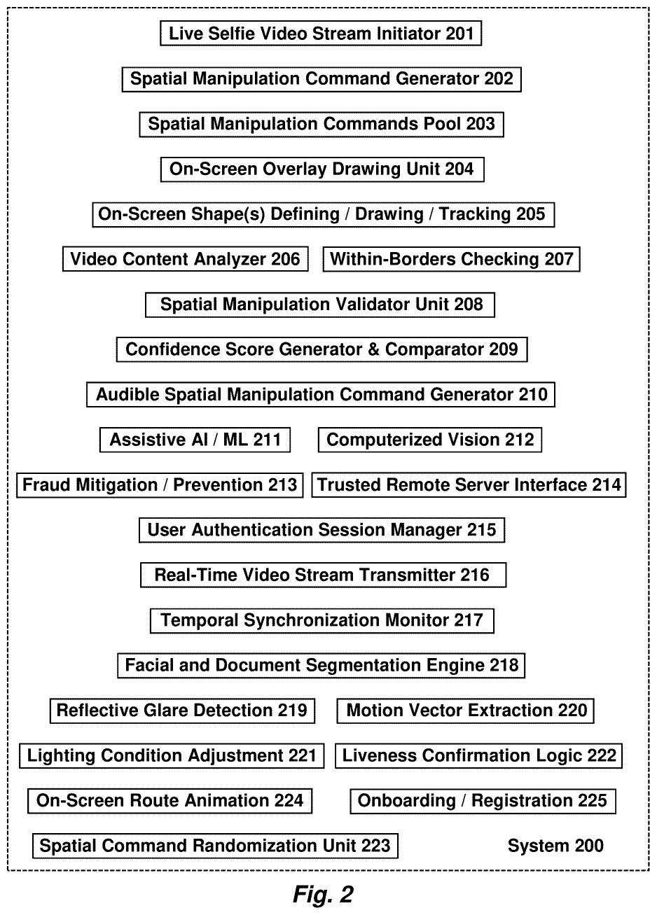

Reference is made to FIG. 2, which is a schematic block-diagram illustration of a system 200, in accordance with some demonstrative embodiments. System 200 may be implemented using hardware components and/or software components. The components of system 200 may be distributed across multiple devices; for example, some of the components (e.g., the video capturing sub-system, the on-screen drawing sub-system) may run locally on the end-user electronic device; some of the components (e.g., video content analysis unit) may run remotely on a trusted remote server. Some functionalities may optionally be implemented using a mobile application or “app”, or using a native application or using an in-browser application, or using program code running in a browser (e.g., using JavaScript and/or HTML5 and/or CSS) and/or using client-side script/s and/or using server-side script/s, or may be implemented as a stand-alone application or as a stand-alone web browser, or may be implemented as a browser extension/add-on/plug-in/toolbar, or may be implemented as an extension/add-on/plug-in of another program or of another application (e.g., a banking application, a brokerage application, a securities trading application, a crypto-currency trading application, and e-commerce application). Some of the components describe herein, and/or their respective functionality, may be optional in some implementations; or may not necessarily be included in all implementations.

Live Selfie Video Stream Initiator 201 operates as the primary module responsible for activating, configuring, and maintaining a continuous live video capture process from the front-facing camera of the electronic device. It interfaces directly with the camera sensor array and image signal processor (ISP) to initialize video feed parameters such as frame rate, resolution, compression codec, and dynamic range optimization. The module continuously monitors available bandwidth, processor load, and lighting intensity to dynamically adjust capture parameters, ensuring stable frame acquisition under variable conditions. The Initiator 201 also handles session metadata creation, embedding timestamps, geolocation data, and hardware identifiers into the live feed header structure. It integrates with the Real-Time Video Stream Transmitter 216 to establish a secure transmission handshake, encrypting the outgoing stream using device-specific session keys. The Initiator 201 triggers the Assistive AI/ML Unit 211 to calibrate color balance and exposure for facial clarity and document legibility. During live operation, it synchronizes with the Temporal Synchronization Monitor 217, emitting periodic frame-sequence markers that are later used for temporal alignment verification. Through bidirectional communication with the User Authentication Session Manager 215, the module can pause, resume, or restart video capture sequences in response to user input or automated validation commands. This continuous coordination ensures that the live selfie video feed remains authenticated, consistent, and correctly formatted for downstream analysis by the Video Content Analyzer 206 and other dependent subsystems.

Spatial Manipulation Command Generator 202 is a computational logic unit responsible for dynamically generating commands that instruct the user to perform specific spatial movements of the identification document or facial gestures. It receives contextual parameters from the Spatial Manipulation Commands Pool 203, selects or constructs an applicable command, and transmits the instruction data to the On-Screen Overlay Drawing Unit 204 and the Audible Spatial Manipulation Command Generator 210. The module employs algorithmic routines that incorporate randomization, service-type relevance, and environmental constraints, ensuring that each spatial manipulation command is unique within an authentication session. It interfaces with the Assistive AI/ML Unit 211 to evaluate prior user compliance data, thereby predicting the optimal complexity level for the next command. The generator encodes command attributes such as trajectory path, motion direction, angular displacement, and timing thresholds, which are transmitted to the On-Screen Shape(s) Defining/Drawing/Tracking Unit 205 for visual rendering. It continuously exchanges synchronization signals with the Temporal Synchronization Monitor 217 to align command issuance with live video frames captured by the Live Selfie Video Stream Initiator 201. The Spatial Manipulation Command Generator 202 functions as the cognitive core of user-interaction logic, ensuring real-time coordination between visual, auditory, and behavioral layers within the verification pipeline.

Spatial Manipulation Commands Pool 203 operates as a secure and adaptive repository containing a plurality of pre-defined, dynamically modifiable spatial manipulation templates. Each entry in the pool encapsulates multi-dimensional parameters, including trajectory vectors, spatial constraints, motion frequencies, and temporal tolerances. The repository is indexed for rapid retrieval through hashed identifiers linked to session metadata provided by the User Authentication Session Manager 215. The pool interfaces with the Spatial Manipulation Command Generator 202 through an encrypted data bus, enabling retrieval or modification of stored templates based on current user authentication context. The Commands Pool 203 can also receive AI-optimized updates from the Assistive AI/ML Unit 211, which continuously evaluates success rates of previously executed commands and adjusts difficulty or structure accordingly. It supports both static and pseudo-randomized command selection, integrating with the Spatial Command Randomization Unit 223 to ensure unpredictability across authentication sessions. The module also communicates with the Fraud Mitigation/Prevention Unit 213, allowing for the removal or flagging of command patterns that may have been compromised. Internally, the Pool 203 uses redundancy-verified memory blocks and employs versioning control to preserve data integrity. During operation, it delivers command blueprints to the On-Screen Overlay Drawing Unit 204 for rendering, maintaining synchronization with the Temporal Synchronization Monitor 217 to guarantee temporal coherence during user interaction sequences.

On-Screen Overlay Drawing Unit 204 is a visual-rendering subsystem that projects graphical elements, instructional icons, and overlay paths directly onto the device display while the live selfie video stream remains visible in the background. It accepts spatial and geometric data from the Spatial Manipulation Command Generator 202 and converts these into overlay primitives rendered through GPU-accelerated drawing pipelines. The unit supports layered transparency, adjustable luminance contrast, and adaptive scaling to maintain visibility under various lighting conditions as detected by the Lighting Condition Adjustment Module 221. Real-time rendering synchronization is achieved through continual feedback with the Live Selfie Video Stream Initiator 201 to ensure the overlays align with current frame orientation. The Overlay Drawing Unit 204 also establishes communication with the On-Screen Shape(s) Defining/Drawing/Tracking Unit 205, transmitting coordinate boundaries and movement trajectories. Visual updates are propagated in sub-frame intervals to ensure minimal latency, and vector-based interpolation ensures smooth motion of moving shapes or indicators. The system maintains a rendering priority queue where verification-critical overlays are allocated reserved CPU/GPU cycles to prevent frame skipping or stuttering. The Overlay Drawing Unit 204 further supports dynamic instruction updates, allowing overlays to evolve in response to real-time behavioral feedback analyzed by the Video Content Analyzer 206 and Liveness Confirmation Logic Unit 222.

On-Screen Shape(s) Defining/Drawing/Tracking Unit 205 operates as a precision subsystem that defines geometric boundaries, trajectories, and dynamic shape motion parameters for visual overlays associated with spatial manipulation commands. It integrates input parameters received from the Spatial Manipulation Command Generator 202 and translates them into coordinate matrices defining positional vectors across X, Y, and Z axes. The unit employs real-time shape instantiation using OpenGL or equivalent low-level graphical APIs, maintaining sub-pixel accuracy through vector-based rendering and continuous calibration against live video feed motion data. Shape tracking logic operates in coordination with the Computerized Vision Unit 212, enabling continuous verification that the identification document remains within predefined borders. The Tracking Unit communicates with the Within-Border Checking Unit 207 (or a Within-Boundaries Checking Unit), relaying coordinate deltas and tracking events for boundary compliance analysis. It utilizes predictive interpolation algorithms to maintain visual stability during rapid device or hand movement, and dynamically updates path trajectories when environmental lighting or occlusion conditions change as detected by the Reflective Glare Detection Unit 219. Furthermore, the unit outputs timestamped position metadata to the Temporal Synchronization Monitor 217 for subsequent validation by the Spatial Manipulation Validator Unit 208. Its bidirectional link with the On-Screen Overlay Drawing Unit 204 ensures graphical coherence between rendered overlays and analytical reference frames. Through its combined rendering, definition, and tracking capabilities, this unit forms the core geometric engine that visually enforces and monitors user compliance during the verification process.

Video Content Analyzer 206 is a computational subsystem designed to process each incoming video frame of the live selfie stream in real time, extracting, classifying, and quantifying multiple visual parameters that are relevant to authentication and fraud prevention. The Analyzer 206 incorporates both deterministic and probabilistic vision algorithms, combining convolutional neural network inference with classical image-processing routines for pattern detection, contrast normalization, and feature localization. It receives frame sequences directly from the Live Selfie Video Stream Initiator 201 and employs time-indexed buffers to correlate spatial movements with temporal progression, under supervision of the Temporal Synchronization Monitor 217. The Analyzer 206 cooperates with the Facial and Document Segmentation Engine 218 to isolate facial regions, document boundaries, and background noise clusters, and transmits these segmented subframes to the Confidence Score Generator & Comparator 209 for quantitative evaluation. Embedded within the module is a spectral-frequency discriminator capable of detecting frame anomalies such as flicker patterns, re-encoded frame artifacts, and pixel noise inconsistencies characteristic of replay or spoofed content. The Analyzer 206 continuously receives configuration parameters from the Assistive AI/ML Unit 211, which refines its thresholds and learning weights based on session-level historical data. Output from this unit is structured as multi-layer metadata packets containing positional vectors, liveness indicators, and detected geometric correlations, transmitted downstream to the Spatial Manipulation Validator Unit 208 for logical compliance testing. The Video Content Analyzer 206 thereby serves as the core interpretive hub transforming raw video data into structured analytical evidence suitable for subsequent decision-making and authentication scoring.

Within-Border Checking Unit 207 functions as a high-precision spatial logic processor that determines whether the on-screen depiction of the identification document or face remains within the geometric confines defined by the On-Screen Shape(s) Defining/Drawing/Tracking Unit 205. The unit performs continuous pixel-coordinate mapping between the tracked object contours provided by the Computerized Vision Unit 212 and the static or dynamic border definitions received from the Tracking Unit 205. A real-time matrix comparison engine operates at frame-level granularity, computing Euclidean distance metrics and angular offsets to verify positional adherence. The unit maintains rolling buffers that store the last N coordinate states, allowing for tolerance analysis of transient deviations such as minor hand tremors or camera shake. Synchronization signals from the Temporal Synchronization Monitor 217 ensure that the evaluation window is temporally consistent with active manipulation intervals commanded by the Spatial Manipulation Command Generator 202. When boundary breaches exceed pre-defined thresholds, the Within-Border Checking Unit 207 dispatches corrective alerts to the On-Screen Overlay Drawing Unit 204, triggering dynamic color changes or movement prompts for immediate user correction. It also relays compliance statistics to the Spatial Manipulation Validator Unit 208 for inclusion in overall session integrity scoring. The internal processing pipeline operates under deterministic timing constraints to ensure sub-100-millisecond latency per evaluation cycle, maintaining real-time visual tracking integrity across variable network and device conditions.

Spatial Manipulation Validator Unit 208 consolidates analytical data streams from multiple subsystems to determine whether the user has correctly executed the spatial manipulation command. It receives border-compliance results from the Within-Border Checking Unit 207, motion-sequence data from the Motion Vector Extraction Unit 220, and liveness indicators from the Liveness Confirmation Logic Unit 222. The Validation Unit processes these heterogeneous inputs through a multi-stage logic tree that assesses timing, orientation, and trajectory conformity relative to the instruction blueprint originally generated by the Spatial Manipulation Command Generator 202. Each command execution is represented as a multidimensional signature vector, encapsulating spatial coordinates, velocity curves, and temporal markers. The Validator Unit 208 compares this signature against the expected reference template stored in the Spatial Manipulation Commands Pool 203. A weighted confidence algorithm determines the degree of compliance, which is forwarded to the Confidence Score Generator & Comparator 209. The unit interfaces with the Fraud Mitigation/Prevention Unit 213, triggering predefined response actions such as re-prompting, additional verification layers, or session termination when non-compliance persists. Communication with the Assistive AI/ML Unit 211 allows adaptive tuning of tolerance parameters, refining sensitivity thresholds based on real-world user variance. Operating as the logical adjudicator of movement validity, this unit ensures that both intentionality and accuracy are conclusively verified before authentication approval.

Confidence Score Generator & Comparator 209 operates as a quantitative assessment engine that calculates numerical confidence levels representing the likelihood that the spatial manipulation has been genuinely executed by the authorized user. It aggregates multidimensional data outputs from the Video Content Analyzer 206, Spatial Manipulation Validation Unit 208, and Liveness Confirmation Logic Unit 222, applying normalization and weighting algorithms to produce a unified score. The Generator 209 uses a hybrid model combining deterministic rule-based metrics with probabilistic inference layers trained by the Assistive AI/ML Unit 211. It maintains two separate scoring domains: a visual domain measuring geometric and motion precision, and a temporal domain evaluating synchronization fidelity with command timing signals provided by the Temporal Synchronization Monitor 217. The Comparator subsystem within the module performs real-time evaluation of each confidence score against dynamic threshold curves that adapt to environmental noise, lighting conditions, and device performance as communicated by the Lighting Condition Adjustment Module 221. If the computed score falls below acceptable levels, an immediate feedback loop is initiated to the User Authentication Session Manager 215 and Fraud Mitigation/Prevention Unit 213, which can reinitiate verification sequences or enforce escalation procedures. The module logs all scoring events into the Secure Session Logging Database 227 (if present) for audit purposes. Through this tightly integrated scoring pipeline, the Confidence Score Generator & Comparator 209 converts complex visual and temporal analytics into an interpretable authentication confidence index.

Audible Spatial Manipulation Command Generator 210 is responsible for synthesizing and outputting audio-based cues that mirror or complement the on-screen spatial manipulation instructions generated by the Spatial Manipulation Command Generator 202. The unit incorporates a digital signal synthesis engine capable of generating human-like speech or tonal indicators using locally cached phonetic models and waveform libraries. It integrates with the Assistive AI/ML Unit 211 to adjust speech tone, clarity, and timing according to environmental acoustics detected by the device's microphone array. The module receives synchronization metadata from the Temporal Synchronization Monitor 217 to ensure audio cues coincide precisely with visual overlay transitions displayed by the On-Screen Overlay Drawing Unit 204. Acoustic latency compensation algorithms continuously adjust playback timing to account for device hardware variation and network-induced frame delays. The Audible Generator 210 can operate in dual-mode (e.g., speech instruction and tonal feedback) where tonal sequences signify successful compliance detected by the Spatial Manipulation Validation Unit 208. It employs an adaptive noise-suppression layer that dynamically modulates audio amplitude based on ambient background noise intensity. The unit maintains communication with the User Authentication Session Manager 215 for session control and multilingual customization and can also issue immediate corrective verbal prompts when boundary violations are reported by the Within-Border Checking Unit 207. This component thus provides an additional sensory channel ensuring that spatial instructions remain perceptible and unambiguous, even in visually constrained or low-light environments.

Assistive AI/ML Unit 211 functions as a self-optimizing computational intelligence layer that continuously refines operational parameters across multiple subsystems. It collects large volumes of performance metrics, including user compliance rates, environmental lighting variability, facial movement smoothness, and document tracking accuracy. The unit employs both supervised and reinforcement learning architectures to dynamically adjust thresholds, tolerance levels, and selection logic throughout the verification pipeline. Deep neural inference cores within the AI/ML Unit 211 are trained using multimodal datasets containing annotated examples of successful and failed authentication sessions, enabling adaptive decision boundaries that evolve with continued use. This unit interfaces directly with the Spatial Manipulation Command Generator 202, Confidence Score Generator & Comparator 209, and Video Content Analyzer 206 to provide real-time configuration tuning, ensuring system responsiveness across diverse device environments. Feedback loops between this unit and the Liveness Confirmation Logic Unit 222 maintain dynamic model calibration against the latest liveness-detection heuristics. The module also manages version-controlled machine learning models stored in secure, encrypted containers, transmitting incremental parameter updates to the Trusted Remote Server Interface 214 for federated learning synchronization. Each inference event is tagged with temporal and environmental metadata provided by the Temporal Synchronization Monitor 217 and Lighting Condition Adjustment Module 221, supporting model retraining on contextualized performance data. Through continuous optimization and adaptive inference, the Assistive AI/ML Unit 211 provides the system with evolving intelligence, minimizing false rejections and maximizing authentication robustness.

Computerized Vision Unit 212 serves as a high-performance perception engine dedicated to real-time visual feature extraction, object recognition, and geometric tracking of user and document elements within each video frame. It receives raw pixel data from the Live Selfie Video Stream Initiator 201 and performs multi-stage image transformations, including noise suppression, edge detection, contour enhancement, and color-space normalization. Using embedded convolutional neural networks and optical flow algorithms, the Vision Unit 212 identifies critical reference points such as facial landmarks, document corners, and spatial orientation vectors. These extracted data structures are broadcast to the Within-Border Checking Unit 207 for boundary verification and to the Motion Vector Extraction Unit 220 for trajectory computation. The Vision Unit collaborates with the Facial and Document Segmentation Engine 218 to separate overlapping regions and prevent analytical cross-contamination between facial and document imagery. It maintains constant synchronization with the Temporal Synchronization Monitor 217 to ensure sequential alignment between frame processing and spatial command execution. Internally, the module uses GPU-accelerated tensor operations to maintain sub-20-millisecond frame inference latency. It further provides adaptive recalibration feedback to the Lighting Condition Adjustment Module 221 when illumination conditions degrade recognition reliability. Operating as the central perception node, the Computerized Vision Unit 212 transforms unstructured optical data into structured analytic primitives used across the system's authentication logic.

Fraud Mitigation/Prevention Unit 213 functions as the system's security enforcement core, continuously monitoring analytical data streams to detect anomalies indicative of fraudulent behavior, spoofing attempts, or unauthorized access. It aggregates results from the Confidence Score Generator & Comparator 209, Spatial Manipulation Validation Unit 208, and Video Content Analyzer 206 to construct a behavioral integrity profile for each session. The module maintains a fraud-detection rule set that integrates heuristic detection methods with learned risk models received from the Assistive AI/ML Unit 211. Upon detection of deviations from normal behavioral patterns (such as latency inconsistencies, mirrored frame artifacts, or identical spatial gesture repetitions) the unit triggers countermeasures including additional authentication challenges, immediate session lockdowns, or logging to the Secure Session Logging Database 227. It communicates directly with the User Authentication Session Manager 215 to enforce escalation protocols and with the Trusted Remote Server Interface 214 for secure anomaly reporting to backend monitoring systems. A cryptographic auditing process records all high-risk events, embedding cryptographic hashes into transaction metadata for non-repudiation. The Fraud Mitigation/Prevention Unit 213 continuously receives updated fraud pattern signatures from cloud-based analytic frameworks through secure channels, ensuring that detection logic evolves in real time with emerging threats. Acting as the system's defensive intelligence layer, this component ensures authentication integrity even in adversarial or simulated attack environments.

Trusted Remote Server Interface 214 provides a secure communication gateway between the local device subsystem and one or more remote trusted servers for off-device processing, data storage, and synchronization. It establishes cryptographically protected channels using asymmetric key exchanges and dynamic session tokens, ensuring confidentiality and authenticity of transmitted data. The interface manages packetized transmission of live video frames, analytics metadata, and machine learning updates between the device and the remote infrastructure. It collaborates closely with the Real-Time Video Stream Transmitter 216 to maintain continuous low-latency video uplink during authentication sessions. The Interface 214 is designed with a fail-safe buffer management system, allowing temporary local caching of un-transmitted frames during connectivity interruptions, followed by priority-based retransmission. It also handles incoming policy updates, AI model parameters, and fraud-detection rules originating from the backend, distributing them to appropriate subsystems including the Assistive AI/ML Unit 211 and Fraud Mitigation/Prevention Unit 213. The Interface continuously verifies digital certificates and cryptographic keys against a remote authority to prevent spoofing or man-in-the-middle attacks. It integrates with the Temporal Synchronization Monitor 217 to ensure timestamp consistency across distributed environments. This unit serves as the authenticated bridge that securely binds localized edge processing with centralized trust infrastructure.

User Authentication Session Manager 215 oversees initiation, orchestration, and termination of authentication sessions, maintaining consistent control across all interconnected subsystems. It acts as a supervisory process manager that monitors component readiness, user engagement status, and validation progress. The module initializes the Live Selfie Video Stream Initiator 201 and coordinates the timing of command issuance from the Spatial Manipulation Command Generator 202 in accordance with user interaction events. It establishes and manages session identifiers, tokenizing each session with cryptographically secure random strings to ensure traceability and non-reusability. The Session Manager interacts with the Confidence Score Generator & Comparator 209 to receive scoring outputs, determining session outcomes and triggering either acceptance or re-verification workflows. It maintains synchronization with the Temporal Synchronization Monitor 217 for accurate timestamp registration across subsystems. The Session Manager also communicates bidirectionally with the Fraud Mitigation/Prevention Unit 213 to enforce policy-based escalation or adaptive verification routines when suspicious activity is detected. All session logs, including command issuance timestamps, user response latencies, and computed confidence metrics, are written to the Secure Session Logging Database 227. The User Authentication Session Manager 215 therefore functions as the operational backbone of the system, ensuring procedural coherence, timing discipline, and controlled resource management across the entire authentication sequence.

Real-Time Video Stream Transmitter 216 serves as the high-throughput communication layer responsible for the secure and continuous transmission of the live selfie video feed from the local device to external or remote processing infrastructure. The Transmitter operates through an adaptive streaming protocol optimized for low-latency multimedia transport, dynamically balancing bitrate and frame resolution according to bandwidth availability and processor load. The module incorporates packet fragmentation and sequence indexing logic, ensuring frame continuity and reliable reassembly at the receiving end. It works in conjunction with the Trusted Remote Server Interface 214 to perform cryptographic encapsulation using symmetric encryption keys derived from a device-specific key-exchange handshake. The Transmitter also utilizes forward error correction algorithms to mitigate data loss in unstable network conditions, while a real-time monitoring subroutine analyzes transmission quality and dynamically adjusts encoding parameters such as quantization level, frame rate, and color compression. Integration with the Temporal Synchronization Monitor 217 ensures that transmitted frames retain absolute timing consistency, enabling accurate comparison with command execution timestamps. The Real-Time Video Stream Transmitter 216 also provides acknowledgment feedback to the Live Selfie Video Stream Initiator 201, confirming packet receipt and enabling retransmission if frame integrity verification fails. Through its integration with the Fraud Mitigation/Prevention Unit 213, the module can also detect anomalous transmission interruptions or duplicated streams indicative of spoofing or replay attempts. By maintaining synchronized, encrypted, and verified video transmission, this unit provides the secure pipeline through which authentic visual data flows throughout the authentication architecture.

Temporal Synchronization Monitor 217 is the system's master timing controller, ensuring temporal coherence across all concurrently operating modules. It generates high-precision timestamps using the device's internal clock, periodically calibrated against network time protocol (NTP) references to maintain sub-millisecond synchronization accuracy. Each video frame, command instruction, and analytic event is tagged with a monotonic timestamp generated by the Monitor, enabling temporal correlation throughout the verification workflow. The Monitor 217 operates through bidirectional synchronization channels linking the Live Selfie Video Stream Initiator 201, Spatial Manipulation Command Generator 202, and Video Content Analyzer 206, ensuring all time-sensitive operations execute in deterministic order. The Monitor continuously evaluates drift between system components and automatically compensates for cumulative timing offsets by adjusting internal clocks using polynomial interpolation models. It also manages delay compensation for the Real-Time Video Stream Transmitter 216 and Trusted Remote Server Interface 214 to counteract transmission latency. In verification mode, the Monitor provides temporal windowing data to the Spatial Manipulation Validation Unit 208 and Confidence Score Generator & Comparator 209, enabling these modules to measure the exact timing correlation between user movement and issued command prompts. The Temporal Synchronization Monitor 217 thus ensures a unified chronological framework, essential for reliable, auditable, and reproducible authentication events.

Facial and Document Segmentation Engine 218 performs high-speed semantic partitioning of the live video feed into distinct pixel clusters corresponding to facial regions, identification documents, and environmental background. Utilizing hybrid deep-learning segmentation networks combined with traditional edge-detection and region-growing algorithms, the Engine isolates spatially coherent structures based on texture gradients, chromatic profiles, and geometric symmetry. It receives raw or preprocessed frame data from the Computerized Vision Unit 212 and outputs labeled segmentation masks to the Video Content Analyzer 206 and Within-Border Checking Unit 207. The Engine operates on a multithreaded pipeline architecture capable of handling parallel segmentation tasks across multiple frames, maintaining a throughput of at least 30 frames per second on typical consumer hardware. It continuously synchronizes with the Lighting Condition Adjustment Module 221 to recalibrate threshold parameters in response to illumination variation, ensuring segmentation consistency under fluctuating lighting conditions. The Engine also collaborates with the Reflective Glare Detection Unit 219 to identify glare-contaminated regions and either compensate for or exclude them from the analysis pipeline. Output segmentation data includes polygonal boundary coordinates and confidence maps, which are utilized downstream by the Spatial Manipulation Validation Unit 208 for compliance assessment. By providing accurate object delineation, the Facial and Document Segmentation Engine 218 ensures that all analytic subsystems operate on correctly classified and isolated visual entities, reducing false positives and maximizing overall system precision.

Reflective Glare Detection Unit 219 identifies and compensates for optical reflections or glare artifacts that may obscure critical portions of the identification document or facial area within the live video feed. It analyzes luminance gradients, specular highlight distributions, and localized saturation levels using frequency-domain and histogram-based evaluation methods. The module receives continuous frame inputs from the Video Content Analyzer 206 and provides pixel-level glare masks to the Facial and Document Segmentation Engine 218 and Lighting Condition Adjustment Module 221. The Detection Unit applies a combination of temporal averaging and adaptive thresholding to distinguish transient glare caused by momentary movement from persistent reflective interference. It employs spatial filtering and entropy-based analysis to isolate non-uniform reflection patterns, then computes a glare probability matrix for each frame. This data enables dynamic reconfiguration of exposure settings by the Live Selfie Video Stream Initiator 201 or lighting compensation by the Lighting Condition Adjustment Module 221. The Reflective Glare Detection Unit 219 can also trigger a re-prompt sequence via the On-Screen Overlay Drawing Unit 204 if critical document regions are obstructed beyond an acceptable threshold. The module integrates tightly with the Temporal Synchronization Monitor 217, tagging detected glare intervals for post-process correlation during validation. Operating as a visual integrity safeguard, this unit preserves analytical visibility and prevents false mismatches arising from uncontrolled optical reflections.

Motion Vector Extraction Unit 220 computes directional movement, velocity, and acceleration vectors corresponding to the user's face, hands, and identification document across consecutive video frames. It utilizes optical flow estimation techniques (e.g., Lucas-Kanade and Farnebäck algorithms), supplemented with feature-tracking kernels accelerated through GPU computation. The module interfaces directly with the Computerized Vision Unit 212 and Video Content Analyzer 206, which supply frame-sequence data and extracted key points. The Motion Vector Extraction Unit 220 generates a continuous stream of three-dimensional motion data, incorporating both translational and rotational components derived from pixel displacement fields. It maintains close synchronization with the Temporal Synchronization Monitor 217 to ensure accurate time-based velocity calculations and temporal alignment with the spatial manipulation commands issued by the Spatial Manipulation Command Generator 202. These motion vectors are transmitted to the Spatial Manipulation Validation Unit 208 for trajectory conformity analysis and to the Confidence Score Generator & Comparator 209 for incorporation into the overall compliance score. The unit can also detect anomalous motion patterns, such as inconsistent acceleration curves or unnatural periodic motion, which are flagged for review by the Fraud Mitigation/Prevention Unit 213. Through precise motion quantification and frame-to-frame continuity analysis, the Motion Vector Extraction Unit 220 provides the dynamic metrics required to verify authenticity of user actions within the spatial manipulation framework.

Lighting Condition Adjustment Module 221 operates as an adaptive optical environment controller that dynamically calibrates exposure, gain, and color balance parameters of the live video feed to maintain consistent image quality across variable illumination conditions. The module continuously monitors scene brightness, contrast ratios, and white balance using real-time photometric data derived from the Video Content Analyzer 206 and Reflective Glare Detection Unit 219. It employs histogram equalization, gamma correction, and localized tone-mapping algorithms to normalize luminance across facial and document regions without introducing visual artifacts. The module interfaces directly with the Live Selfie Video Stream Initiator 201 to adjust camera settings through low-level driver APIs, enabling frame-by-frame exposure correction. The Lighting Condition Adjustment Module 221 also provides feedback signals to the Assistive AI/ML Unit 211, which incorporates illumination metrics into its predictive learning models for improved environmental adaptability. During authentication, it ensures that critical identification document features, such as printed text, holographic seals, and color gradients, remain visually distinct for accurate recognition by the Computerized Vision Unit 212. The module maintains tight synchronization with the Temporal Synchronization Monitor 217 to ensure that lighting adjustments do not disrupt frame timing or analytic consistency. By stabilizing visual conditions in real time, the Lighting Condition Adjustment Module 221 ensures optimal visibility and uniform image quality throughout the authentication sequence, thereby reducing analytic noise and enhancing verification reliability.

Liveness Confirmation Logic Unit 222 is a subsystem dedicated to verifying that the subject participating in the authentication process is a live human rather than a static or synthetic representation. It analyzes subtle motion cues, depth fluctuations, and micro-expression changes across successive video frames, drawing input from the Motion Vector Extraction Unit 220 and Computerized Vision Unit 212. The unit executes multi-layer feature correlation tests, comparing temporal variations in skin texture, pupil dilation, and facial muscle dynamics to statistical models of natural human motion. It interfaces with the Assistive AI/ML Unit 211 to refine detection thresholds through adaptive learning based on previously validated sessions. The Liveness Confirmation Logic Unit 222 also integrates optional audio and depth-sensing inputs (when available) from peripheral sensors, allowing cross-modal validation between visual and acoustic responses. Temporal data alignment is maintained through coordination with the Temporal Synchronization Monitor 217 to ensure that motion and visual analysis correspond precisely to the issued spatial manipulation command intervals. Detection of abnormal motion periodicity, repetitive patterns, or perfectly linear trajectories triggers alerts to the Fraud Mitigation/Prevention Unit 213, prompting additional verification challenges. This component's logic layer outputs a binary liveness verdict and a numerical confidence coefficient, both of which are supplied to the Confidence Score Generator & Comparator 209 for cumulative scoring. Through complex behavioral verification and sensor-level data fusion, the Liveness Confirmation Logic Unit 222 ensures that the authentication process cannot be compromised through presentation or replay attacks.

Spatial Command Randomization Unit 223 ensures unpredictability and resistance to automated replay attacks by introducing algorithmic entropy into the selection and sequencing of spatial manipulation commands. It operates as a controlled randomness engine interfacing with the Spatial Manipulation Command Generator 202 and the Spatial Manipulation Commands Pool 203. The unit employs cryptographically secure pseudo-random number generators (CSPRNGs) seeded by system entropy sources, including timestamp deltas from the Temporal Synchronization Monitor 217 and environmental noise captured through the device's sensor array. Each randomization event produces a command selection index, determining which pre-defined movement pattern or on-screen trajectory will be utilized during the session. The module ensures compliance with service-type constraints and user capability metrics received from the Assistive AI/ML Unit 211, maintaining operational diversity while preserving usability. The Spatial Command Randomization Unit 223 also communicates with the Fraud Mitigation/Prevention Unit 213 to log entropy metrics, supporting forensic analysis of command sequence uniqueness. When integrated with multi-session authentication environments, it guarantees that no two command sequences are statistically identical within defined time intervals. The Randomization Unit thereby strengthens system resilience against predictive modeling, replayed motion data, and pre-recorded spoof attempts by ensuring each authentication instance exhibits cryptographic and behavioral uniqueness.

On-Screen Route Animation Unit 224 (or, On-Screen Path Animation Unit) governs the dynamic rendering of animated trajectory paths or motion routes displayed to the user during execution of spatial manipulation commands. It receives vector path definitions from the Spatial Manipulation Command Generator 202 and converts them into continuously animated overlays synchronized with the live video feed rendered by the On-Screen Overlay Drawing Unit 204. The unit utilizes GPU-accelerated interpolation algorithms to achieve sub-frame motion smoothness, maintaining alignment with current frame rendering parameters as supplied by the Temporal Synchronization Monitor 217. It interacts with the Lighting Condition Adjustment Module 221 to ensure that visual brightness and contrast of animated paths remain visible under variable ambient light. The Animation Unit also interfaces with the Within-Border Checking Unit 207 to receive feedback regarding document tracking accuracy, dynamically altering trajectory visuals or pacing speed when deviations are detected. When coupled with the Audible Spatial Manipulation Command Generator 210, the unit synchronizes visual and auditory cues, creating multimodal guidance for the user. All trajectory animation parameters, including duration, velocity profile, and curvature, are logged and transmitted to the Confidence Score Generator & Comparator 209 for cross-validation with observed user motion vectors from the Motion Vector Extraction Unit 220. Operating as a real-time guidance display engine, the On-Screen Route Animation Unit 224 enhances user compliance, reduces execution error rates, and provides an interactive visual scaffold for spatial verification sequences.

Onboarding/Registration Module 225 facilitates the initial user enrollment process by capturing, storing, and structuring baseline biometric, behavioral, and device-level parameters that define the reference identity profile. It initializes upon first system access and coordinates with the Live Selfie Video Stream Initiator 201 to acquire high-fidelity facial imagery and identification document data under controlled capture conditions. The module performs identity data structuring, including template generation, feature vector extraction, and cryptographic hashing of stored biometric signatures. It integrates with the Trusted Remote Server Interface 214 to upload reference data securely to authorized back-end storage with encryption and checksum verification. The Onboarding/Registration Module 225 communicates with the Assistive AI/ML Unit 211 to train initial model baselines using the user's own data, thereby enabling personalized threshold calibration for future sessions. It establishes secure user credentials and generates unique identifiers that link the stored reference profile to subsequent authentication events managed by the User Authentication Session Manager 215. The module also synchronizes environmental calibration data, including typical lighting patterns and camera characteristics, which are stored for adaptive reuse by the Lighting Condition Adjustment Module 221. All registration events are logged with temporal signatures validated by the Temporal Synchronization Monitor 217. Through secure data capture, structured feature extraction, and bidirectional calibration, the Onboarding/Registration Module 225 forms the foundational reference framework against which all future verification processes are measured.

In some embodiments, a verification platform operates on a consumer device and initializes a forward-facing sensor to capture a continuous self-view stream while establishing cryptographic session metadata. The capture pipeline configures frame cadence, optical gains, and color matrices based on instantaneous device telemetry. A timing controller publishes monotonically increasing markers so that downstream processes align motion prompts, visual overlays, and analytic events to a shared temporal reference. The initialization sequence configures compression parameters and reserves dedicated compute lanes for real-time perception, scoring, and secure transmission.

In accordance with some embodiments, the system issues spatial directives that instruct a registrant to manipulate a credential or to perform specific facial gestures while remaining visible within a shared frame. A directive composer selects a movement template from a protected repository, applies entropy from a cryptographically seeded source, and parameterizes trajectory vectors, durations, and angular tolerances. The composer then delivers synchronized visual and audible cues to the display and speaker subsystems. Each directive carries a unique token that binds motion expectations to subsequent analysis and audit records.

In some implementations, on-screen graphics are rendered as translucent guides, bounding polygons, or animated routes that move along predefined paths. A rendering engine produces vector primitives with sub-pixel interpolation and maintains alignment with the active camera projection. Brightness and contrast of the overlays are tuned according to ambient luminance so that the guides remain discernible without obscuring fine features of the document or face. A tracking routine updates overlay positions as the user or device shifts, preserving registration between the guides and the perceived scene.

In some embodiments, a perception module transforms raw frames into structured observations. The module computes feature points, edge maps, and region masks that separate facial areas, document extents, and background texture. Optical flow estimators generate motion vectors across sequential frames, while corner detectors locate stable anchor points near document borders. A segmentation engine outputs labeled masks together with confidence maps that capture uncertainty around boundaries and partially occluded regions, which supports downstream tolerance handling and corrective prompts.

In accordance with some embodiments, border adherence is evaluated by comparing tracked object polygons to the overlay boundaries that define permissible locations. Coordinate tuples are sampled at a programmable rate and processed through a geometric comparator that tolerates minor hand tremor and camera micro-jitter. Deviations beyond prescribed thresholds raise a nonconformity event that can trigger a corrective visual indicator, an audible cue, or an automatic reissue of the directive. The comparator stores a short temporal window of states to differentiate brief excursions from sustained misalignment.

In some implementations, temporal fidelity is verified by correlating motion measurements with directive timing. A clock supervisor aligns command issuance, frame acquisition, and analytic computations using calibrated offsets. The system computes arrival skew, inter-frame gaps, and playback jitter to detect anomalies consistent with replay sources or edited media. When drift exceeds acceptable bounds, the supervisor initiates pacing adjustments, requests renewed timing anchors from a remote authority, or flags the session for added scrutiny within the scoring stage.

In some embodiments, a liveness evaluator inspects micro-movements, skin reflectance variability, eye dynamics, and depth cues when available. The evaluator measures non-linearities in motion profiles and compares them to human biomechanical patterns. Deterministic checks and learned classifiers cooperate to identify repetitive loops, planar artifact behavior, or frequency signatures typical of display-based presentation. The evaluator publishes a binary indicator along with a probability measure that quantifies the strength of the liveness finding for later combination with other metrics.

In accordance with some embodiments, visual quality controls mitigate conditions that degrade recognition. A lighting regulator adjusts exposure and white balance parameters in coordination with the camera stack and may apply localized tone mapping to preserve text legibility and holographic markers on the credential. A glare detector computes highlight histograms and specular heatmaps to isolate intense reflections. Regions affected by glare can be excluded from certain measurements or can prompt the user to reorient the document until reflectance subsides below a configured limit.

In some implementations, a validator consolidates geometric, temporal, and liveness observations to decide whether the directive was satisfied. The validator constructs a signature vector containing path conformity, speed profile alignment, rotational adherence, and border compliance results. Reference vectors derived from the directive template are compared using weighted distances. The outcome is forwarded to a scoring engine that fuses multiple validators across the session, applies context-sensitive weights, and produces a session confidence value against adaptive thresholds that reflect environmental difficulty.

In some embodiments, adaptive intelligence refines parameters using cumulative experience. Learning models receive anonymized metrics for successful and unsuccessful attempts, stratified by device type, ambient light, and user behavior. The models propose updated tolerances, route complexities, and audio phrasing to improve completion rates without weakening resistance to misuse. Model parameters are versioned, signed, and distributed through a trusted interface. Devices adopt new parameters after validity checks, with rollback paths that permit recovery if resource constraints or accuracy regressions are detected.

In accordance with some embodiments, secure communications support off-device processing and fleet coordination. A remote interface negotiates keys, validates certificates, and streams encoded frames and analytics packets over authenticated channels. A transmitter performs adaptive bitrate selection, forward error correction, and packet sequencing to preserve continuity under variable connectivity. Audit trails record directive identifiers, timestamps, scores, and notable events in an append-only structure. When indicators of misuse accumulate, a mitigation controller can request additional directives, pause the workflow, or end the attempt according to policy.

In some implementations, an enrollment workflow captures baseline exemplars and establishes a durable reference profile. The workflow collects high-quality facial samples and document imagery under guided illumination, computes feature descriptors, and stores cryptographic hashes and metadata that describe capture conditions. Subsequent verifications reference the stored descriptors while accounting for expected day-to-day variation. Enrollment also calibrates device-specific optics and establishes default overlay scale factors, thereby improving stability of border checks and motion guidance during later sessions.

In some embodiments, the directive selector emphasizes unpredictability while maintaining clarity for the user. A randomization engine draws entropy from multiple sources and composes sequences that avoid repetition within a defined horizon. The selector can incorporate service context to vary complexity, for example by choosing shorter routes in constrained bandwidth or longer routes when liveness confidence is low. Generated sequences are logged with entropy metrics so that the uniqueness of a session can be reconstructed during forensics.

In accordance with some embodiments, the system coordinates multimodal guidance to reduce execution errors. Animated routes, pointer cues, and boundary highlights are synchronized with speech instructions that describe the action and timing. Acoustic latency compensation aligns audio playback with visual transitions and frame timing. If the user deviates from the guided trajectory, the route can slow, pause, or visually widen, while the audible component issues succinct corrective phrases. This coordination improves compliance without concealing the live scene behind opaque elements.

In some implementations, the platform performs continual health checks across the pipeline. Resource monitors measure CPU and GPU utilization, frame queue depth, and memory pressure. If saturation threatens real-time operation, the system selectively scales inference precision, reduces overlay detail, or lowers frame resolution while preserving temporal integrity. Health events are recorded together with their effect on scores to maintain transparency around conditions that could affect interpretation of the results. This allows consistent behavior across a wide range of devices.

In some embodiments, the architecture supports modular deployment topologies. Certain computations remain on the device for latency and privacy, while heavier tasks can be delegated to a trusted backend when permitted. The same message schemas and timing semantics apply in both modes so that results remain comparable. Policy objects specify which features are enabled, which thresholds are active, and which responses are available upon detection of irregularities. Policy changes are signed, distributed, and enforced at runtime.

In accordance with some embodiments, the platform exposes well-defined interfaces for integration with enrollment services, risk engines, and audit repositories. Each session yields structured outputs that include final confidence, intermediate metrics, and rationale indicators necessary for regulatory review. Partner systems can request re-verification by pushing a new directive sequence token. The invention's layered controls, synchronized timing, randomized guidance, and analytics fusion provide a consistent mechanism for verifying that a present individual manipulated a physical credential or performed gestures while remaining within a defined visual context.

Some embodiments provide a computerized method comprising: (a) initiating a live selfie video stream of a user on an electronic device; (b) concurrently capturing a video-frame of said live selfie video feed both (b1) a face of the user and (b2) an identification document of the user; (c) generating a spatial manipulation command that instructs the user to perform a particular spatial manipulation of the identification document while also maintaining both the face of the user and the identification document concurrently within a same video-frame; (d) analyzing visual content of the live video stream to reach a determination of whether or not the live video stream depicts that the user has correctly performed the spatial manipulation command; and if not, then: performing one or more pre-defined fraud mitigation operations or fraud prevention operations.

In some embodiments, step (c) comprises: drawing a particular on-screen shape on a screen of the electronic device while the screen shows a currently-captured live video stream of the user; generating a spatial manipulation command that instructs the user to spatially position the identification document at a spatial location such that an on-screen depiction of the identification document would appear within borders of said particular on-screen shape.

In some embodiments, step (c) comprises: drawing a first particular on-screen shape and a second particular on-screen shape, on a screen of the electronic device while the screen shows a currently-captured live video stream of the user; generating a spatial manipulation command that instructs the user to concurrently perform the following two operations: (i) to spatially position the identification document at a first spatial location such that an on-screen depiction of the identification document would appear within borders of the first particular on-screen shape, and also, (ii) to spatially position the face of the user at a second spatial location such that an on-screen depiction of the face of the user would appear within borders of the second particular on-screen shape.

In some embodiments, step (c) comprises: drawing a first particular on-screen shape and a second particular on-screen shape, on a screen of the electronic device while the screen shows a currently-captured live video stream of the user; generating a spatial manipulation command that instructs the user to concurrently perform the following two operations: (i) to spatially position the identification document at a first spatial location such that an on-screen depiction of the identification document would appear within borders of the first particular on-screen shape, and also, (ii) to spatially position the face of the user at a second spatial location such that an on-screen depiction of the face of the user would appear within borders of the second particular on-screen shape; wherein the step of drawing the first particular on-screen shape and a second particular on-screen shape comprises: selecting non-overlapping particular locations for the first particular on-screen shape and a second particular on-screen shape to ensure that placement of the identification document at the first spatial location does not obstruct the face of the user that is commanded to be spatially located at the second spatial location.

In some embodiments, step (c) comprises: drawing a first particular on-screen shape and a second particular on-screen shape, on a screen of the electronic device while the screen shows a currently-captured live video stream of the user; generating a spatial manipulation command that instructs the user: (i) to spatially position a front side of the identification document at a first spatial location such that an on-screen depiction of the identification document would appear within borders of the first particular on-screen shape, and also, (ii) to concurrently spatially position the face of the user at a second spatial location such that an on-screen depiction of the face of the user would appear within borders of the second particular on-screen shape; and then, (iii) to then flip over the identification document such that a back side of the identification document would appear within borders of said particular on-screen shape.

In some embodiments, step (c) comprises: drawing a particular on-screen shape on a screen of the electronic device while the screen shows a currently-captured live video stream of the user; generating a spatial manipulation command that instructs the user (i) to spatially position a front side of the identification document at a spatial location such that an on-screen depiction of the identification document would appear within borders of said particular on-screen shape, and (ii) to then flip over the identification document such that a back side of the identification document would appear within borders of said particular on-screen shape.

In some embodiments, step (d) comprises: analyzing visual content of the live video stream to reach a determination of whether or not at least one video-frame depicts, correctly and concurrently, (i) the face of the user, and (ii) the identification document; and wherein the analyzing further comprises checking whether a face of the user as shown in the identification document is sufficiently similar to the face of the user as concurrently captured in the live video stream, beyond a pre-defined threshold level of visual similarity.

In some embodiments, generating the spatial manipulation command further comprises: generating a command that instructs the user to perform a particular modification of his face or his body, to confirm liveness and to prevent replay attacks.

In some embodiments, step (c) comprises: selecting the spatial manipulation command pseudo-randomly from a pool of pre-defined spatial manipulation commands, to prevent replay attacks.

In some embodiments, step (c) comprises: selecting the spatial manipulation command from a pool of pre-defined spatial manipulation commands, to prevent replay attacks, based on a pre-defined set of selection rules that take into account at least the type of service to which the user is registering. For example, a first rule may be defined and enforced such that a request from a user to open a new savings account in a bank would require the identification document to be a driver license and would require the spatial manipulation command to be an instruction to place the driver license within a static rectangle that appears above the face of the user in the selfie video; whereas, a second rule may be defined and enforced such that a request from a user to open a new cryptocurrency account in a cryptocurrency exchange would require the identification document to be a passport and would require the spatial manipulation command to be an instruction to place the passport within a moving rectangle that appears on the left side of the face of the user in the selfie video.

In some embodiments, step (d) comprises: transmitting the live video feed in real-time to a trusted remote server; wherein step (d) of analyzing visual content of the live video stream is performed remotely on said trusted remote server.

In some embodiments, step (c) comprises: drawing a particular on-screen shape on a screen of the electronic device while the screen shows a currently-captured live video stream of the user, and causing movement of the particular on-screen shape on the screen of the electronic device in accordance with a particular on-screen route; generating a spatial manipulation command that instructs the user: (i) to spatially position the identification document at a spatial location such that an on-screen depiction of the identification document would appear within borders of said particular on-screen shape, and (ii) to continuously move the identification document spatially such that the on-screen depiction of the identification document would remain within borders of said particular on-screen shape as it moves in accordance with said particular on-screen route.

In some embodiments, the method further comprises: generating an overlay animated content-item, that is presented as an overlay on top of the screen of the electronic device while it shows the live selfie video stream; wherein the overlay animated content-item guides the user which spatial manipulation is required.

In some embodiments, step (c) comprises: generating the spatial manipulation command as an audible command that audibly instructs the user to spatially perform a particular spatial manipulation of the identification document.

In some embodiments, step (d) comprises: (d1) calculating a confidence score indicating a degree of compliance of the user with the spatial manipulation command; (d2) comparing the confidence score to one or more pre-defined threshold values, to determine whether or not to perform fraud prevention operations or fraud mitigation operations.

In some embodiments, step (d) comprises: feeding one or more video frames of the video selfie stream as input into a pre-trained Machine Learning model; and generating by said Machine Learning model a classification output that indicates whether or not video content depicts that the user complied with the spatial manipulation command.

In some embodiments, step (d) comprises executing a compliance-classification pipeline in which one or more video frames, or a short temporal window of the video selfie stream, are fed into a pre-trained Machine Learning model that has been optimized to recognize whether the depicted motion pattern corresponds to the issued spatial manipulation command. The model may accept raw RGB frames at a specified resolution, optionally accompanied by auxiliary signals such as per-frame face landmarks, head pose estimates, optical-flow fields, inertial readings if available from the device, and timestamps that allow recovery of motion velocities. The model may output a classification score indicating compliance or non-compliance, a confidence value, and optionally one or more continuous quantities such as the estimated displacement vector in image coordinates, an estimated angular rotation around a camera axis, or an estimated change in distance between the camera and the face derived from scale variation of facial landmarks.

In accordance with some embodiments, the Machine Learning model is a temporal network that consumes a sequence of K frames sampled from the stream at a controlled cadence. The network may be implemented as a three-dimensional convolutional network, a temporal convolutional network, a recurrent neural network with gated units, or a transformer encoder with positional encodings that preserve frame order. A spatial backbone, such as a residual convolutional stack, may extract per-frame features. A temporal head may integrate these features to capture motion trends that distinguish, for example, a device translation to the left versus a rotation in yaw of the user's head. Training may use supervised labels that indicate whether the subject complied with a particular command within the observed window, together with auxiliary regression targets that quantify direction and magnitude. The final layer can produce logits for the classes “complied,” “not complied,” and “inconclusive,” where “inconclusive” captures insufficient motion or poor quality frames, allowing the decision logic to request additional frames rather than force a binary outcome.

In some implementations, the model is conditioned on the command type so that a single shared network can evaluate many distinct spatial manipulations without training a separate classifier for each. Command conditioning may be achieved by mapping the command text or a structured command identifier into an embedding vector, and concatenating or gating this vector into intermediate layers. For example, a command “move the drive license to the left” may map to a template motion profile in normalized image coordinates, while “rotate the driver license clockwise” may map to an angular profile around the optical axis. During inference, the same video window is scored against the specified command embedding so that the output represents compliance with respect to that particular instruction. This design improves parameter sharing across commands and supports rapid addition of new commands with limited incremental data.

In some embodiments, training data is assembled as a multi-source corpus that includes captured sequences from consenting participants, scripted sessions with hired actors performing each command across diverse lighting and backgrounds, and synthetically generated sequences created by applying geometric transforms to base clips. The synthetic component can produce controlled translations, rotations, and scale changes while preserving photorealistic noise such as motion blur or sensor gain artifacts. To improve generalization across devices, clips may be collected at multiple frame rates and focal lengths, and then normalized by temporal resampling and letterboxing strategies that preserve aspect ratio. Labels may be produced through a hybrid workflow: automated algorithms first estimate optical flow, head pose, and landmark trajectories to propose a compliance label along with quantitative displacement magnitudes, and human annotators then verify or correct those proposals within an annotation interface that visualizes motion traces over time.

In accordance with some embodiments, the training objective is a multi-task loss that combines a cross-entropy term for the compliance class with regression losses for displacement or rotation amounts when available. A confidence calibration term may be applied through temperature scaling or isotonic regression on a held-out validation set so that the reported confidence correlates with empirical accuracy. Class imbalance is addressed by sampling strategies that equalize compliant and non-compliant windows for each command category, and by employing focal loss variants to emphasize hard negatives such as partial motions that start in the correct direction but fail to meet magnitude or dwell-time thresholds. Data augmentation may include photometric jitter, synthetic motion blur, compression artifacts, and occlusion masks. For commands that depend on left versus right, horizontal flips are disabled or relabeled appropriately to preserve semantic correctness.

In some implementations, an additional geometric measurement module runs alongside the classifier and computes interpretable motion signals, including average optical flow in predefined regions of interest, variance of facial landmark positions, and estimated head pose changes derived from a perspective-n-point solver using a canonical 3D face model. The Machine Learning model may consume these signals as auxiliary inputs. This hybrid design helps the network disambiguate similar appearance changes that arise from translation versus rotation. The geometric module can also impose simple rule checks, such as minimum pixel displacement over N consecutive frames, and pass its intermediate results to the post-processing stage to produce reason codes that explain a negative decision.

In some embodiments, the inference stage processes the live stream with a sliding temporal window. For each window, the model emits a compliance probability p and optional regression outputs. A decision layer then aggregates across windows using a temporal logic that requires both a minimum magnitude and a minimum dwell time where the compliant state persists for at least N frames. Thresholds can be command specific and are learned or tuned using receiver operating characteristic and precision-recall analyses on a validation set. The decision layer may also compute an estimated time to compliance and may expose this value to a guidance component that informs the user when further movement is needed.

In accordance with some embodiments, the system supports several command families. For translation commands, the model focuses on the sign and magnitude of the displacement vector in image coordinates. For rotation commands, the model estimates roll, yaw, or pitch changes either from facial landmarks or from global optical-flow curl statistics. For proximity commands, the model tracks scale change of the face region or of a fiducial marker and verifies movement direction toward or away from the camera. For centering commands, the model estimates the offset between a target region and the image center and detects whether the offset decreases below a tolerance. The same conditioning mechanism allows the network to adapt its internal attention to the appropriate cues for the requested family.

In some implementations, the pre-training phase initializes the spatial backbone on large-scale human-centric video datasets containing head movements, gestures, and face tracking tasks. Self-supervised objectives such as future frame prediction, temporal order verification, or contrastive instance discrimination may be used to improve the motion sensitivity of the features without manual labels. After pre-training, the network is fine-tuned on the command-specific dataset described above. Transfer learning reduces the amount of proprietary commanded data required to reach a target accuracy and helps the model remain robust to backgrounds and attire variation that are not directly relevant to the spatial command.

In some embodiments, the model is quantized and pruned to meet device constraints while retaining accuracy. Mixed-precision inference may be used, with sensitive layers kept at higher precision. Where privacy policies require on-device processing, both the feature extraction and temporal head run locally and emit only a compact decision record such as class label, confidence, and summary motion statistics. Where server processing is permitted, frames may be sent in encrypted form and decoded in a secure enclave, allowing larger models or ensemble methods to be employed. The ensemble can average probabilities from heterogeneous architectures and reduce variance in challenging conditions such as low light or rapid motion.

In accordance with some embodiments, the training and evaluation protocols incorporate adversarial and edge cases, including slow drifts that test dwell-time logic, oscillatory motions that cancel net displacement, and replayed videos displayed on secondary screens. The dataset includes negative samples where the motion direction is opposite to the requested command or where magnitude is below threshold. The final system exposes a tunable abstain region around the decision boundary so that low-confidence windows are marked “inconclusive,” and additional frames are requested. This approach aligns the classification output with downstream risk policy, allowing the system to escalate or retry rather than commit to a brittle decision when evidence is weak.

In some embodiments, step (d) comprises: feeding one or more video frames of the video selfie stream as input into a large Vision-and-Language Model (VLM) model; and generating by said large Vision-and-Language Model (VLM) model an output that indicates whether or not video content depicts that the user complied with the spatial manipulation command.

In some embodiments, step (d) comprises executing a multimodal inference procedure in which one or more video frames from the video selfie stream and a textual representation of the spatial manipulation command are provided as joint input to a large Vision and Language Model (VLM) or a large Language and Vision Model (LVM) or other large multi-modal model or large multiple-modalities model (LMM or LMMM).

For example, the Vision and Language Model may be architected with a visual encoder that produces dense embeddings for each frame or for a short temporal clip, a text encoder that embeds the command phrasing or a normalized command token, and a fusion module that aligns and conditions the visual features on the semantic content of the command. The fusion module may be a cross attention transformer in which the command tokens attend to spatiotemporal visual tokens, or a gated projection in which command embeddings modulate subsequent visual layers. The model generates an output that indicates whether the depicted motion complies with the specified spatial instruction within a defined temporal horizon, optionally accompanied by calibrated confidences, an abstain flag when evidence is insufficient, and auxiliary signals that quantify observed displacement, rotation, or centering progress.

In accordance with some embodiments, the input preparation stage selects a sequence of K frames sampled at a cadence that balances temporal coverage with computational limits. The frames may be resized to a canonical resolution and normalized using per channel statistics. To preserve motion information, frames can be stacked as a clip tokenized into patches with learned positional encodings that encode both spatial coordinates and frame indices. The text side may consist of the verbatim instruction given to the user, such as move the phone to the left, or a structured canonical form that maps each command family into a normalized template with parameters for direction, magnitude threshold, and dwell time. The system may append context tokens that describe device configuration, camera facing mode, or prior partial progress so that the model evaluates compliance in the proper operating context.

In some implementations, the Vision and Language Model is trained in two stages. A pretraining stage exposes the model to large corpora of paired vision language data to learn general alignment between visual events and natural language descriptions. This pretraining can include public or licensed datasets of human actions, gestures, head pose changes, and device motions where captions or annotations describe the visual content in neutral language. The vision backbone learns to encode faces, hands, and background geometry robustly, while the text backbone learns to embed instruction semantics. A fine-tuning stage then specializes the model for commanded spatial manipulation. The fine-tuning dataset contains clips collected from controlled sessions where participants receive explicit commands and perform translations, rotations, proximity changes, and centering motions under varied lighting and device poses. Each clip is labeled with the command issued, the time span during which compliance occurred, and quantitative measurements derived from optical flow, landmark tracks, or inertial proxies. Negative examples include partial motions, motions in the wrong direction, stationary sequences, and replayed content presented on secondary displays.

In some embodiments, synthetic data generation augments the commanded dataset by applying geometric transforms to base clips in a manner that approximates device motion while preserving realistic sensor artifacts. Camera left and right translations can be simulated by spatial warps that maintain perspective consistency, rotations can be approximated by in plane roll with anti-aliasing, and proximity changes can be synthesized by scale adjustments of the face region guided by landmark meshes. Text prompts are generated to match each synthetic transform so that the model experiences a diverse mapping between language and motion outcomes. To avoid semantic drift, a labeling pipeline combines automated motion analysis with human verification. Annotators review proposed compliance intervals in an interface that overlays motion vectors and head pose traces, correct start and stop times, and confirm the correctness of the command association.

In accordance with some embodiments, instruction tuning is applied so that the Vision and Language Model responds reliably to compliance questions. The model can be trained with prompt templates that mirror the deployed inference prompt, for example by presenting the command as a query and the video tokens as context, then supervising the model to output a structured response. The response may be a compact string that encodes a label such as complied, not complied, or inconclusive and may optionally include numeric fields such as observed magnitude and estimated orientation change. During training, the system penalizes deviations from the expected schema using token level losses and applies label smoothing to improve calibration. To reduce overfitting to particular phrasings, the same command is paraphrased in multiple ways, and the model is required to produce consistent decisions across paraphrases.

In some implementations, the model is trained to produce both discriminative outputs and lightweight rationales that pinpoint the visual regions or frames that were most influential. Rather than natural language explanations, which may leak unnecessary content, the model returns attention maps or token importance scores. These signals can be used by downstream logic to produce human readable reason codes, such as insufficient leftward displacement across three consecutive windows or rotation observed but duration below threshold. The system can learn these attributions by supervising the attention heads with soft masks derived from optical flow magnitude or landmark motion, encouraging the model to focus on relevant areas without constraining it to a single cue.

In some embodiments, few shot conditioning is supported. The inference prompt may include one or two short exemplars that pair a miniature clip thumbnail and a text description with an outcome label that matches the current command. The exemplars are drawn from a small on device cache that reflects the user's camera and environment, or from curated prototypes stored on the server. This approach allows the Vision and Language Model to adapt its internal decision boundary to the specific optics, frame rate, and noise profile without full retraining. The system can measure the gain from exemplars on a validation stream and fall back to zero shot mode if the exemplars introduce bias.

In accordance with some embodiments, the output layer produces a probability of compliance conditioned on the command and the observed frames. A temperature parameter calibrated on a held-out set ensures that probability values correspond to empirical accuracy. An abstain band around the decision threshold protects against low signal conditions. The model may also emit a trajectory vector that describes the direction of motion in image coordinates and a progress scalar that monotonically increases as the user approaches compliance. These auxiliary outputs allow the guidance component to provide immediate feedback, such as continue moving left two centimeters in image space, while the classification decision remains pending until the dwell time requirement is met.

In some implementations, privacy and efficiency constraints influence deployment. If on device evaluation is required, the visual encoder may be quantized and the fusion layers pruned while retaining the text encoder in full precision to preserve instruction semantics. If server-side evaluation is permitted, encrypted frame batches may be sent to a secure execution environment where a larger Vision and Language Model or an ensemble of complementary models can be run, and only compact decision records are returned. The system may maintain a rolling buffer of embeddings rather than raw frames so that repeated evaluation across overlapping windows avoids redundant computation.

In some embodiments, robustness is validated with a test suite that includes oscillatory motions that alternate left and right without net displacement, slow drifts that test dwell time logic, occlusions from hands or objects, and presentation attacks where prerecorded compliant sequences are displayed on another screen. The Vision and Language Model is evaluated on these cases with metrics for true accept rate at fixed false accept rate, abstention frequency, and calibration error. Thresholds are chosen based on the intended risk posture of the surrounding workflow. If the model returns inconclusive on multiple consecutive windows, the system can escalate by requesting a different spatial manipulation that is orthogonal to the last command so that a second modality of motion evidence is collected before a final decision is made.

In some embodiments, the terms “drawing” or “displaying” as used herein may include:
causing the screen of the end-user electronic device (e.g., smartphone, tablet, laptop computer, desktop computer) to display an on-screen graphical element, such as a rectangle or oval or circle or polygon or arrow(s) or other on-screen indicator; such as, for example, by generating and displaying an overlay layer of graphics as a foreground layer, or as a partially-transparent layer or overlay component or as a partially see-through element or layer or overlay component, while the selfie video is still shown and displayed on that screen as a background layer. Such causing may be performed based on a locally-generated command in the electronic device and/or based on a remotely-generated command in a remote server, or based on a combination of both (e.g., a signal or command from the remote server triggers the end-user device to locally perform the on-screen drawing).

In some embodiments, the terms “drawing” or “displaying” include programmatically causing the end-user device to render a foreground graphics layer on top of the live selfie video, which continues to play as a background layer in the same viewport. The foreground layer can be a composited overlay created by the device's graphics subsystem using alpha blending, z-ordering, and per-primitive shaders. The overlay may include rectangles that bound a target region, circles that indicate required centering, ovals that gate a face region, arrows that indicate the target motion direction, or polygons that delineate acceptable zones of compliance. The rendering pipeline can rely on native APIs, such as hardware-accelerated surfaces, Metal or Vulkan contexts, or WebGL canvases, and can maintain a fixed update cadence that is locked to the video frame rate to avoid judder. Coordinate transforms map model coordinates, which are often expressed in normalized image space, to device pixels after accounting for aspect ratio, letterboxing, sensor orientation, and front-camera mirroring. The system may apply safe-area constraints to avoid notches or status bars and can quantize geometry to device pixel grids to preserve crisp edges on high-density screens.

In accordance with some embodiments, the decision to draw a particular on-screen graphical element, along with its geometry and animation parameters, is produced locally, remotely, or cooperatively. A remote server may transmit a compact drawing command that specifies primitive type, control points in normalized coordinates, stroke width, color, opacity, animation easing, and lifespan. The device may validate the command against current viewport state and perform final layout. Alternately, the device may synthesize the command locally based on intermediate signals such as face landmarks, head pose estimates, or detected motion vectors. To reduce bandwidth, a hybrid mode can be used in which the server emits intent tokens, for example “left translation guidance,” and the device resolves these tokens into concrete primitives that match the current camera matrix and screen size.

In some embodiments, a Machine Learning model selects or parameterizes the overlay, so that on-screen guidance adapts to the user's pose, distance, and ambient conditions. The model can be trained in a supervised manner to predict the overlay primitive and geometry that minimize task completion time or maximize compliance rate. Training data can include video selfie recordings paired with ground-truth overlay annotations that were either created by expert designers or derived from heuristic controllers with human curation. Each training sample may contain raw RGB frames or frame embeddings from a visual backbone, facial landmark coordinates, head pose angles, inertial sensor readings when available, and historical overlay states. Labels may include the chosen primitive type, a set of control points for geometry, an expected dwell duration, and a discretized animation style. The model may take as input the current frame features together with a text or token representation of the active spatial manipulation command. The output can include a distribution over primitive types, continuous geometry parameters in normalized coordinates, a confidence value, and a predicted utility score that estimates expected user progress.

In some implementations, the model is a lightweight fusion network with a visual encoder and a command encoder followed by a small transformer that attends over recent frames. A separate head predicts geometry via bounded regression, while another head predicts visibility and opacity so that overlays fade in or out smoothly. Losses can combine cross-entropy for primitive selection, L1 or Huber for geometry, and a calibration loss for confidence. The training corpus can be assembled from scripted sessions where participants follow commands in diverse environments, and from synthetic sequences that simulate camera translations, rotations, and scale changes. Synthetic overlays are generated by a rule engine and treated as pseudo-labels to increase coverage. An evaluation set may measure placement accuracy, temporal stability, and downstream compliance gains. In alternative embodiments, a reinforcement learning variant is used, where the policy emits overlay parameters and receives a reward based on measured improvement in compliance indicators such as reduction in centering error or attainment of required displacement within a time budget. Privacy constraints may be satisfied by training on-device with federated averaging and by logging only anonymized overlay statistics rather than raw video.

In some embodiments, the computerized method is implemented as part of a computerized process that is selected from the group consisting of: a process for creating a new user account at a bank, a process for creating a new user account at a financial institution, a process for creating a new user account at a brokerage firm, a process for creating a new user account at a securities trading provider, a process for creating a new user account at a cryptocurrency exchange, a process for creating a new user account at a credit card provider, a process for creating a new user account at a financial service provider, a new-user onboarding process for a computerized service; a new-user registration process for a computerized service.

In some embodiments, the identification document is an item selected from the group consisting of: a driver license, a passport, a government-issued photo ID card, a credit card, a banking card, a birth certificate, a utility bill, a bank statement, a health insurance card.

In some embodiments, a Spatial Manipulation Command is generated by a command-orchestration service that receives context from the verification workflow, evaluates policy, and selects a command template from a catalog of predefined instruction types. The catalog may include translation, rotation, proximity, and centering families, together with visual guidance primitives such as rectangles, circles, arrows, or masked regions. Each template defines a semantic intent, a set of parameters with admissible ranges, and validation criteria that a downstream classifier or Vision and Language Model will use to determine compliance. The selection process can be conditioned on device capabilities, network quality, prior user progress, and security posture. For example, if the prior step produced a borderline compliance score, the selector may prefer a command that elicits a larger displacement or a motion that is orthogonal to the last observed trajectory. If the device reports limited rendering performance, the selector may choose a static overlay rather than an animated path.

In accordance with some embodiments, even when the instruction is drawn from a predefined pool, the system introduces non-deterministic variation or permutation within bounded ranges to reduce the risk of scripted replay. The command template can declare parameters such as target rectangle width, target rectangle height, permitted offset, animation speed, and dwell time. Each parameter is associated with a closed interval or a discrete set of allowed values. The selector samples an assignment from these ranges using a cryptographically strong random number generator that is seeded per session. For instance, the template may specify that the ID card rectangle should have a height between V1 and V2 in normalized image units, and the sampling procedure chooses a value that is later embedded in the command payload. Similarly, the animation controller may receive a speed parameter sampled from S1 to S2, which results in visible variation in how fast a guideline rectangle traverses the screen. The sampled values are attached to a unique command identifier and a nonce so that the same instruction cannot be reused outside of the session. The seed, nonce, and parameter choices can be recorded in a server-side audit log and optionally embedded as signed metadata so that a verifier can reconstruct expected behavior if a dispute arises.

In some embodiments, construction of the Spatial Manipulation Command yields a self-describing payload with versioned fields that specify command type, parameter schema, and timing semantics. The payload may include a canonical command token, a human readable prompt, a structured object that encodes geometry in normalized coordinates, temporal constraints such as maximum time to initiate motion and minimum dwell time at the target, and visualization directives for the overlay layer. The payload can also carry optional modality hints for the compliance engine, for example, whether to rely primarily on face landmarks or global flow. A signature block may cover the payload with a server private key, together with a timestamp and a short expiry. The end user device verifies the signature using a pinned public key to ensure the command originated from an authorized server. The payload can be serialized in JSON for simplicity, Protocol Buffers for compactness, or CBOR when the transport involves constrained devices. Each serialization includes a schema version so that clients can negotiate feature support.

In accordance with some embodiments, the server conveys the command to the device over a secure channel using HTTPS with mutual authentication, WebSockets for low latency streaming, or gRPC for bidirectional control. The transport can include a sequence number to preserve ordering and a retransmission strategy to handle packet loss. The server may wait for a command acceptance acknowledgment from the device before starting compliance timing, which prevents penalties due to transient network congestion. The device can include in its acknowledgment a capability bitmap that reports supported primitives, maximum overlay layer count, and timing resolution. If the payload references unsupported features, the device requests a downgraded variant and the server regenerates parameters within a compatible template.

In some implementations, upon receipt of the command, the device performs schema validation and signature verification, then registers the command with a local execution engine that maintains a finite state machine. The engine enters a prepare state in which it resolves geometry into device pixels given the current camera transform, safe area insets, and any mirroring applied by the front facing sensor. The engine allocates or reuses a foreground overlay layer, configures primitive shaders, and schedules an animation timeline that respects the start time and speed in the payload. The engine then signals a guidance subcomponent to present the human readable prompt synchronized with the initial overlay state. A motion analysis thread is attached to the command context and begins streaming features to the compliance classifier or Vision and Language Model. The classifier is configured with the command token and numeric thresholds so that it can interpret progress in the intended reference frame.

In some embodiments, a concrete example is an instruction to position an ID card within a rectangle that has randomized size and position. The server selects the “card in frame” template, samples a rectangle height between V1 and V2 and a horizontal offset within a fraction of the viewport width, produces a payload that includes the rectangle center in normalized coordinates, the sampled size, and an allowed tolerance for edge alignment, then signs and transmits the payload. The device draws the rectangle as a semi-transparent rounded box over the selfie video, aligns the geometry to pixel boundaries to avoid shimmering, and evaluates compliance by tracking the card edges and comparing them to the target boundary. If the user rotates the device, the device updates the overlay by applying the tracked camera transform so that the rectangle remains anchored in the intended location. The compliance engine monitors progress and informs the overlay controller to change the stroke color when the user is within tolerance, after which dwell time begins to accrue.

In another example, the server selects a translation command with an animated rectangle that moves laterally. The template defines a path across a percentage of the viewport. The selector samples a speed within S1 to S2 and a start direction selected uniformly at random. The payload encodes the path as a parametric function in normalized coordinates, the sampled speed, and a requirement that the observed face centroid match the path within an error bound for a minimum time. The device instantiates the animation at the indicated speed and synchronizes progress between overlay and classifier by sharing the same path parameter. If frames are dropped, the device advances the overlay based on elapsed time while the classifier integrates observations over the effective frame indices. When the classifier determines that the user has followed the path sufficiently, it emits a compliant result that ends the command.

In accordance with some embodiments, the server may choose commands based on an adaptive policy. The policy maintains a short history of outcomes, estimates which motion families have yielded clear signals, and throttles repetition. When two commands in a row yield marginal confidence, the policy switches to a command with higher expected separability, such as a roll rotation that uses facial landmark derivatives rather than global translation. The policy also introduces fresh randomization of magnitudes and timings within the allowed ranges. The degree of randomization can be increased under higher risk settings, for example when the user is unknown to the system or the transaction value exceeds a threshold.

In some embodiments, execution concludes with a results message that includes the command identifier, the sampled parameters, the compliance label and confidence, and a summary of motion statistics. The device may include a compact digest of overlay timing and any deviations from the nominal path. The server stores the result with the original payload and signature to complete an auditable record. If the command did not achieve conclusive results within a timeout, the server can issue a follow-on command that is conditionally constructed based on the last measured progress, while sampling new parameter values so that scripted responses remain ineffective.

Some embodiments provide a system comprising: one or more hardware processors, that are configured to execute code, and that are operably associated with one or more memory units; wherein the one or more hardware processors are configured to perform a method as described.

Some embodiments provide a non-transitory storage medium having stored thereon instructions that, when executed by a machine, cause the machine to perform a method as described.

Although portions of the discussion herein relate, for demonstrative purposes, to wired links and/or wired communications, some embodiments of the present invention are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be implemented by using hardware units, software units, processors, CPUs, DSPs, GPUs, integrated circuits (ICs), memory units, storage units, wireless communication modems or transmitters or receivers or transceivers, cellular transceivers, a power source, input units, output units, Operating System (OS), drivers, applications, and/or other suitable components.

Some embodiments may be implemented by using a special-purpose machine or a specific-purpose that is not a generic computer, or by using a non-generic computer or a non-general computer or machine. Such system or device may utilize or may comprise one or more units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented by using code or program code or machine-readable instructions or machine-readable code, which is stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such device to perform a method in accordance with the present invention.

Some embodiments may be utilized with a variety of devices or systems having a touch-screen or a touch-sensitive surface; for example, a smartphone, a cellular phone, a mobile phone, a smart-watch, a tablet, a handheld device, a portable electronic device, a portable gaming device, a portable audio/video player, an Augmented Reality (AR) or Virtual Reality (VR) or Mixed Reality (XR) device or headset or gear, a “kiosk” type device, a vending machine, an Automatic Teller Machine (ATM), a laptop computer, a desktop computer, a vehicular computer, a vehicular dashboard, a vehicular touch-screen, or the like.

The system(s) and/or device(s) of some embodiments may optionally comprise, or may be implemented by utilizing suitable hardware components and/or software components; for example, processors, processor cores, Central Processing Units (CPUs), Digital Signal Processors (DSPs), circuits, Integrated Circuits (ICs), controllers, memory units, registers, accumulators, storage units, input units (e.g., touch-screen, keyboard, keypad, stylus, mouse, touchpad, joystick, trackball, microphones), output units (e.g., screen, touch-screen, monitor, display unit, audio speakers), acoustic microphone(s) and/or sensor(s), optical microphone(s) and/or sensor(s), laser or laser-based microphone(s) and/or sensor(s), wired or wireless modems or transceivers or transmitters or receivers, GPS receiver or GPS element or other location-based or location-determining unit or system, network elements (e.g., routers, switches, hubs, antennas), and/or other suitable components and/or modules.

The system(s) and/or devices of some embodiments may optionally be implemented by utilizing co-located components, remote components or modules, “cloud computing” servers or devices or storage, client/server architecture, peer-to-peer architecture, distributed architecture, and/or other suitable architectures or system topologies or network topologies.

In accordance with some embodiments, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit, a Flash drive), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C #, Java, JavaScript, SQL, Ruby on Rails, Go, Cobol, Fortran, ActionScript, AJAX, XML, JSON, Lisp, Eiffel, Verilog, Hardware Description Language (HDL), BASIC, Visual BASIC, MATLAB, Pascal, HTML, HTML5, CSS, Dart, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

Some embodiments of the present invention may perform steps or operations such as, for example, “determining”, “identifying”, “comparing”, “checking”, “querying”, “searching”, “matching”, and/or “analyzing”, by utilizing, for example: a pre-defined threshold value to which one or more parameter values may be compared; a comparison between (i) sensed or measured or calculated value(s), and (ii) pre-defined or dynamically-generated threshold value(s) and/or range values and/or upper limit value and/or lower limit value and/or maximum value and/or minimum value; a comparison or matching between sensed or measured or calculated data, and one or more values as stored in a look-up table or a legend table or a list of reference value(s) or a database of reference values or ranges; a comparison or matching or searching process which searches for matches and/or identical results and/or similar results and/or sufficiently-close results (e.g., within a pre-defined threshold level of similarity; such as, within 5 percent above or below a pre-defined threshold value), among multiple values or limits that are stored in a database or look-up table; utilization of one or more equations, formula, weighted formula, and/or other calculation in order to determine similarity or a match between or among parameters or values; utilization of comparator units, lookup tables, threshold values, conditions, conditioning logic, Boolean operator(s) and/or other suitable components and/or operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Repeated use of the phrase “in one embodiment” does not necessarily refer to the same embodiment, although it may. Repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may comprise, or may be implemented by using, an “app” or application which may be downloaded or obtained from an “app store” or “applications store”, for free or for a fee, or which may be pre-installed on a computing device or electronic device, or which may be transported to and/or installed on such computing device or electronic device.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may comprise any possible combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some embodiments have been illustrated and described herein, many modifications, substitutions, changes, and equivalents may occur to those skilled in the art. Accordingly, the claims are intended to cover all such modifications, substitutions, changes, and equivalents.

What is claimed is:

1. A computerized method comprising:
(a) initiating a live selfie video stream of a user on an electronic device;
(b) concurrently capturing a video-frame of said live selfie video feed both (b1) a face of the user and (b2) an identification document of the user;
(c) generating a spatial manipulation command that instructs the user to perform a particular spatial manipulation of the identification document while also maintaining both the face of the user and the identification document concurrently within a same video-frame;
(d) analyzing visual content of the live video stream to reach a determination of whether or not the live video stream depicts that the user has correctly performed the spatial manipulation command; and if not, then: performing one or more pre-defined fraud mitigation operations or fraud prevention operations.

2. The computerized method of claim 1, wherein step (c) comprises:
drawing a particular on-screen shape on a screen of the electronic device while the screen shows a currently-captured live video stream of the user;
generating a spatial manipulation command that instructs the user to spatially position the identification document at a spatial location such that an on-screen depiction of the identification document would appear within borders of said particular on-screen shape.

3. The computerized method of claim 1, wherein step (c) comprises:
drawing a first particular on-screen shape and a second particular on-screen shape, on a screen of the electronic device while the screen shows a currently-captured live video stream of the user;
generating a spatial manipulation command that instructs the user to concurrently perform the following two operations: (i) to spatially position the identification document at a first spatial location such that an on-screen depiction of the identification document would appear within borders of the first particular on-screen shape, and also, (ii) to spatially position the face of the user at a second spatial location such that an on-screen depiction of the face of the user would appear within borders of the second particular on-screen shape.

4. The computerized method of claim 1,
wherein step (c) comprises:
drawing a first particular on-screen shape and a second particular on-screen shape, on a screen of the electronic device while the screen shows a currently-captured live video stream of the user;
generating a spatial manipulation command that instructs the user to concurrently perform the following two operations: (i) to spatially position the identification document at a first spatial location such that an on-screen depiction of the identification document would appear within borders of the first particular on-screen shape, and also, (ii) to spatially position the face of the user at a second spatial location such that an on-screen depiction of the face of the user would appear within borders of the second particular on-screen shape;
wherein the step of drawing the first particular on-screen shape and a second particular on-screen shape comprises: selecting non-overlapping particular locations for the first particular on-screen shape and a second particular on-screen shape to ensure that placement of the identification document at the first spatial location does not obstruct the face of the user that is commanded to be spatially located at the second spatial location.

5. The computerized method of claim 1,
wherein step (c) comprises:
drawing a first particular on-screen shape and a second particular on-screen shape, on a screen of the electronic device while the screen shows a currently-captured live video stream of the user;
generating a spatial manipulation command that instructs the user: (i) to spatially position a front side of the identification document at a first spatial location such that an on-screen depiction of the identification document would appear within borders of the first particular on-screen shape, and also, (ii) to concurrently spatially position the face of the user at a second spatial location such that an on-screen depiction of the face of the user would appear within borders of the second particular on-screen shape; and then, (iii) to then flip over the identification document such that a back side of the identification document would appear within borders of said particular on-screen shape.

6. The computerized method of claim 1, wherein step (c) comprises:
drawing a particular on-screen shape on a screen of the electronic device while the screen shows a currently-captured live video stream of the user;
generating a spatial manipulation command that instructs the user (i) to spatially position a front side of the identification document at a spatial location such that an on-screen depiction of the identification document would appear within borders of said particular on-screen shape, and (ii) to then flip over the identification document such that a back side of the identification document would appear within borders of said particular on-screen shape.

7. The computerized method of claim 1, wherein step (d) comprises:
analyzing visual content of the live video stream to reach a determination of whether or not at least one video-frame depicts, correctly and concurrently, (i) the face of the user, and (ii) the identification document; and wherein the analyzing further comprises checking whether a face of the user as shown in the identification document is sufficiently similar to the face of the user as concurrently captured in the live video stream, beyond a pre-defined threshold level of visual similarity.

8. The computerized method of claim 1, wherein generating the spatial manipulation command further comprises: generating a command that instructs the user to perform a particular modification of his face or his body, to confirm liveness and to prevent replay attacks.

9. The computerized method of claim 1,
wherein step (c) comprises:
selecting the spatial manipulation command pseudo-randomly from a pool of pre-defined spatial manipulation commands, to prevent replay attacks.

10. The computerized method of claim 1,
wherein step (c) comprises:
selecting the spatial manipulation command from a pool of pre-defined spatial manipulation commands, to prevent replay attacks, based on a pre-defined set of selection rules that take into account at least the type of service to which the user is registering.

11. The computerized method of claim 1, wherein step (d) comprises:
transmitting the live video feed in real-time to a trusted remote server;
wherein step (d) of analyzing visual content of the live video stream is performed remotely on said trusted remote server.

12. The computerized method of claim 1, wherein step (c) comprises:
drawing a particular on-screen shape on a screen of the electronic device while the screen shows a currently-captured live video stream of the user, and causing movement of the particular on-screen shape on the screen of the electronic device in accordance with a particular on-screen route;
generating a spatial manipulation command that instructs the user: (i) to spatially position the identification document at a spatial location such that an on-screen depiction of the identification document would appear within borders of said particular on-screen shape, and (ii) to continuously move the identification document spatially such that the on-screen depiction of the identification document would remain within borders of said particular on-screen shape as it moves in accordance with said particular on-screen route.

13. The computerized method of claim 1, further comprising:
generating an overlay animated content-item, that is presented as an overlay on top of the screen of the electronic device while it shows the live selfie video stream; wherein the overlay animated content-item guides the user which spatial manipulation is required.

14. The computerized method of claim 1, wherein step (c) comprises:
generating the spatial manipulation command as an audible command that audibly instructs the user to spatially perform a particular spatial manipulation of the identification document.

15. The computerized method of claim 1, wherein step (d) comprises:
(d1) calculating a confidence score indicating a degree of compliance of the user with the spatial manipulation command;
(d2) comparing the confidence score to one or more pre-defined threshold values, to determine whether or not to perform fraud prevention operations or fraud mitigation operations.

16. The computerized method of claim 1,
wherein step (d) comprises:
feeding one or more video frames of the video selfie stream as input into a pre-trained Machine Learning model; and generating by said Machine Learning model a classification output that indicates whether or not video content depicts that the user complied with the spatial manipulation command.

17. The computerized method of claim 1,
wherein step (d) comprises:
feeding one or more video frames of the video selfie stream as input into a large Vision-and-Language Model (VLM) model; and generating by said large Vision-and-Language Model (VLM) model an output that indicates whether or not video content depicts that the user complied with the spatial manipulation command.

18. The computerized method of claim 1,
wherein the computerized method is implemented as part of a computerized process that is selected from the group consisting of:
a process for creating a new user account at a bank,
a process for creating a new user account at a financial institution,
a process for creating a new user account at a brokerage firm,
a process for creating a new user account at a securities trading provider,
a process for creating a new user account at a cryptocurrency exchange,
a process for creating a new user account at a credit card provider,
a process for creating a new user account at a financial service provider,
a new-user onboarding process for a computerized service;
a new-user registration process for a computerized service.

19. The computerized method of claim 1,
wherein the identification document is an item selected from the group consisting of:
a driver license,
a passport,
a government-issued photo ID card,
a credit card,
a banking card,
a birth certificate,
a utility bill,
a bank statement,
a health insurance card.

20. A system comprising:
one or more hardware processors that are configured to execute code;
one or more memory units that are configured to store data and code;
wherein the one or more hardware processors are configured to perform a process comprising:
(a) initiating a live selfie video stream of a user on an electronic device;
(b) concurrently capturing a video-frame of said live selfie video feed both (b1) a face of the user and (b2) an identification document of the user;
(c) generating a spatial manipulation command that instructs the user to perform a particular spatial manipulation of the identification document while also maintaining both the face of the user and the identification document concurrently within a same video-frame;
(d) analyzing visual content of the live video stream to reach a determination of whether or not the live video stream depicts that the user has correctly performed the spatial manipulation command; and if not, then: performing one or more pre-defined fraud mitigation operations or fraud prevention operations.
